(19) United States
(12) Patent Application Publication
(10) Pub. No.: US 2020/0024759 A1
(43) Pub. Date: Jan. 23, 2020

(54) HIGH EFFICIENCY ELECTROLYTIC OZONE PRODUCTION SYSTEM

(71) Applicant: Enozo Technologies, Inc., North Andover, MA (US)

(72) Inventors: Jeffrey Davis Booth, Groton, MA (US); Brian Natale Arena, North Reading, MA (US); Rachel Anne Vozikis, Burlington, MA (US); Richard Armando Federico, Reading, MA (US); Carl David Lutz, Andover, MA (US)

(21) Appl. No.: 16/518,519

(22) Filed: Jul. 22, 2019

Related U.S. Application Data
(60) Provisional application No. 62/701,070, filed on Jul. 20, 2018.

(51) Int. Cl. C25B 15/08; C25B 1/13; C25B 9/08; B01D 19/00; B01D 15/10; C02F 1/20; C02F 1/28; C02F 1/467; C02F 1/461; B05B 11/00

(52) U.S. Cl. CPC C25B 15/08; C25B 1/13; C25B 9/08; B01D 19/0042; B01D 15/10; C02F 2303/04; C02F 1/283; C02F 1/4672; C02F 1/46104; B05B 11/0005; C02F 2301/046; C02F 1/20

(57) ABSTRACT

Illustrative embodiments employ catholyte scrubbers to provide higher concentrations of ozone in ozonated water than was possible in prior art systems and methods. Moreover, some embodiments employ scrubbers to increase the efficiency of production of ozonated water by producing such higher concentrations of ozone in ozonated water using the same amount, or less, power than prior art systems and methods. Some embodiments employ scrubbers to enable production of water with higher concentrations of ozone, and/or ozonated water in which the concentration of ozone decays more slowly, as compared to prior art methods.

### RELATED APPLICATIONS

This application claims priority to U.S. Provisional Application No. 62/701,070, filed Jul. 20, 2018, titled “High Efficiency Electrolytic Ozone Production System,” and naming Jeffrey Davis Booth, Brian Natale Arena, Rachel Anne Vozikis, Richard Armando Federico, and Carl David Lutz as inventors [Attorney Docket No. 4540-11201]

The disclosure of the foregoing application is incorporated herein, in its entirety, by reference.

### TECHNICAL FIELD

The present disclosure relates to ozone dispensing apparatuses, and, more particularly, to apparatuses for creating and dispensing ozonated water.

### BACKGROUND ART

Ozone is the triatomic allotrope of oxygen. Ozone is a very strong oxidizing agent that is similar to species such as chlorine (hypochlorous acid, hypochlorite, chlorine dioxide etc.) and hydrogen peroxide, although ozone is a much more powerful oxidant than any of these. One typical application is killing pathogens such as bacterial, mold, viruses etc. Ozone is readily dissolved in water and as such can be used to disinfect water for drinking or actually to turn the water itself into a disinfectant.

Electrolytic cells use electricity at two electrodes to split water molecules and form gases at electrodes. Usually these gases dissolve into the water. At the anode electrons are removed from the water, protons are released into the water and oxygen typically forms on the anode. If a special high overpotential electrode material is used at the anode then it is possible to make ozone as well as diatomic oxygen at the anode. Some examples of high overpotential materials include glassy carbons including boron doped diamond, also platinum, oxides of lead and tin and other materials may be used to electrolytically produce ozone. A necessary part of the electrolytic process is to form hydrogen at the cathode by the recombination the protons in the water and electrons that show up from the supply of electricity to the electrochemical cell.

Electrolysis that forms oxygen has the following formula:

2H₂O(1)→2H₂(g)+O₂(g)

Electrolysis that forms ozone has the following formula:

3H₂O(1)→3H₂(g)+O₃(g)

The anode and cathode of an electrochemical cell can be in free water communication but often this is not the case. For example often a separating barrier is used to facilitate the separation of anodic and cathodic reactants as well as to improve conductivity. In particular solid polymer electrolyte membranes (SPE) also known as proton exchange membranes or (PEM) are often used in the construction of electrolytic cells that make ozone. One example of a SPE is the Dupont product trademarked as Nafion™. The SPE is placed between the anode and cathode and can at least temporarily divide the two sides of the cell to ensure that no ohmic electrical contact is made and temporarily divide the reactants from each side of the cell. In some embodiments the SPE can be effectively used as a complete barrier of each side of the cell.

The flow of water coming out of the anodic side of an electrolytic cell is commonly referred to as anolyte. In an electrolytic ozone cell the anolyte contains ozone. The flow of water coming out of the cathodic side of an electrolytic cell is commonly referred to as catholyte. The catholyte contains hydrogen.

Other constituents or impurities may be present in the water including salts, acids, alcohols, organics, metal ions, dissolved gases and so on.

Sometimes the presence of these constituents may be a requirement of the operation of the cell (example it is designed to work in tap water all across the world and the makeup is not entirely certain). In other cases the presence of the constituents may be added or removed for other purposes or in particular to assist in the production or stabilization of ozone.

Another aspect about electrolytic cells that operate in tap water is that often limescale and similar impurities may form on the cathode of the cell. This is because the high local pH produced near the cathode will easily convert bicarbonate into carbonate and cations such as Ca+2 and Mg+2 will readily also be attracted to the cathode by electrostatic forces. In fact, cation conducting polymer membranes such as Nafion are not selective for only protons, all cations including calcium and magnesium may travel through the membrane. The formation of scale on the cathode means that the life of the cell is dramatically reduced because a high electrical impedance will occur.

As mentioned, special electrode materials are often preferred at the anode to generate ozone. Often these materials are expensive to produce and in some cases such as lead oxide they may require special operational procedures to maintain their effectiveness. Therefore many cells are constructed with a dedicated anode and a dedicated cathode (with a ion conducting barrier in between such as Nafion) where a separates aqueous stream flows across the anode to create an anolyte containing ozone and a separate cathodic side of the cell is created. To deal with the scale formation on these dedicated electrode cells, the catholyte itself may contain a chelating agent such as citric acid, EDTA or something similar. This may present some inconveniences, notably in such a construction the chelating agent reservoir may require maintenance to be able to operate for a long time.

Because of the difficulties associated with a dedicated anode/cathode and chelating agent reservoir often there is a construction where the polarity is switched between anode and cathode. At the anode a different set of conditions exists, in fact there is a locally high concentration of protons and this makes an acidic environment. Acids are known to dissolve limescale. If an electrode previously operated as a cathode with a small amount of limescale formed on its surface is suddenly placed into anodic operation there will be an acidic environment that will dissolve the limescale crystals and effectively restore the electrode surface. However this means that the electrode that was previously making hydrogen now makes ozone and/or oxygen and on the opposite side of the cell the reverse is true. One common construction is to make a cell with two high overpotential electrodes (each capable of making ozone), the cell will then be operated with an electrical circuit that occasionally switches polarity and a plumbing arrangement where the water enters both sides of the cell, forms reactants at both electrodes and then recombines the anolyte and catholyte downstream to produce one mixed stream, see for example U.S. Pat. No. 8,980,079.

The amount of ozone that is created at an electrode often follows Faraday's law of electrolysis. That is, more electrical current will proportionally create more ozone. Of course, cell construction, water flow velocity and other variables may have second order impacts but the chief factor is that increasing current will proportionally increase the mass of ozone produced. The inventors have discovered, however, that ozone concentration in water, and/or the life of ozone in water, may not necessarily be increased by producing more ozone.

One thing about aqueous ozone is that it is very unstable, the very features that make it a strong oxidant also means that it can self-destruct through a number of pathways. The literature often says that the half-life of ozone in water is approximately 20 minutes, but the inventors have found that the half-life of ozone in tap water is realistically closer to 5 minutes but can be a short as 30 seconds, much of it depends upon the other constituents in the water itself.

This is an important aspect because the efficacy of ozone to effectively kill pathogens such as bacteria, mold, yeast and viruses etc. does require a certain amount of contact time. Typically, microbial inactivation studies rely on a metric known as CT which is the multiple of concentration and contact time. If the ozone has a high rate of self-decay then its efficacy can go down substantially.

One of the things about ozone and hydrogen is that they will readily react to form water and heat. Therefore, recombining the anolyte and catholyte will decrease the ozone output both immediately and also will accelerate the rate of destruction of the ozone over time as well. Nonetheless some embodiments of commercial electrolytic ozone generators recombine the anolyte and catholyte because it offers a simple product that could be designed with a single input and output of water.

One known apparatus by the present inventors for delivering ozonated water from a spray bottle is described in US 2013/0206604, which is incorporated herein by reference as if fully set forth. This describes a portable arrangement for generating and dispensing ozonated water using an electrolytic cell. However, it would be desirable to improve the ozone concentration that can be dispensed with this type of device.

### SUMMARY OF VARIOUS EMBODIMENTS

In accordance with an illustrative embodiment, a system for generating ozonated water includes an electrolytic cell having a cell input configured to receive water from a water source and a power input configured to receive electrical power from a power source. The electrolytic cell includes an anode passage in fluid communication with the cell input, the anode passage including an anode and an anode passage outlet, the anode configured to produce ozonated water (the anode stream) at the anode passage outlet; and a cathode passage including a cathode and a cathode passage outlet, the cathode configured to produce a cathode stream at the cathode passage outlet, wherein the cathode passage outlet is fluidly isolated from the anode passage outlet, such that the anode stream is fluidly isolated from the cathode stream. The electrolytic cell also includes an ozonated water output coupled to the anode passage output; and a catholyte discharge conduit including a catholyte scrubber in fluid communication with the cathode passage output and configured to receive the cathode stream.

In some embodiments, the scrubber includes a charcoal scrubber and/or a bubble trap.

In illustrative embodiments, the system also includes a water source in fluid communication with the electrolytic cell to provide source water to the electrolytic cell.

In illustrative embodiments, the system also includes a power source in power communication with the electrolytic cell.

In some embodiments, the electrolytic cell further includes a hydrogen-permeable (PEM) membrane disposed to fluidly isolate the anode passage from the cathode passage.

In illustrative embodiments, the catholyte scrubber has an output in fluid communication with the ozonated water output to combine the scrubbed catholyte with the anolyte.

Other embodiments further include a mixing valve to combine the scrubbed catholyte with the ozonated water. In such embodiments, the catholyte scrubber has an output in fluid communication with the mixing valve; the anode passage output is in fluid communication with the mixing valve, such that the scrubbed catholyte is mixed with the ozonated water in the mixing valve, and the ozonated water output is coupled to the anode passage output via the mixing valve, and the ozonated water output is coupled to the cathode passage output via the catholyte scrubber and the mixing valve.

In other embodiments, the catholyte discharge conduit is in fluid communication with a drain, the drain being fluidly isolated from the water source, wherein the catholyte discharge conduit is configured to deliver catholyte from the cathode passage outlet to the drain downstream from the catholyte scrubber.

Some embodiments also include a catholyte pump in fluid communication with the cathode passage outlet and the cathode passage inlet, the catholyte pump configured to provide catholyte to the cathode passage inlet of the second flow path of the electrolytic cell.

Another embodiment provides a spray bottle apparatus for producing and dispensing ozonated water. The spray bottle apparatus includes a body including a source reservoir configured to hold source water; a head including a nozzle for releasing ozonated water from the bottle; and an electrolytic cell disposed in fluid communication with the nozzle and the source reservoir and configured to ozonate water as the water flows from the source reservoir to the nozzle. The electrolytic cell includes an anode channel having an anode channel output, and a cathode channel having a cathode channel output, in which the cathode channel fluidly isolated from the anode channel. The spray bottle apparatus also includes a catholyte scrubber in downstream fluid communication with the cathode output, and not in fluid communication with the anode channel output, the catholyte scrubber configured to produce scrubbed catholyte.

In some embodiments, the catholyte scrubber includes a charcoal media, a bubble trap, or both a charcoal media and a bubble trap.

In some embodiments, the catholyte scrubber has a scrubber input and a scrubber output, the scrubber input fluidly coupled to the cathode channel output to receive catholyte from the electrolytic cell, and the scrubber output fluidly coupled to the anode channel output so as to combine the scrubbed catholyte with the anolyte from the electrolytic cell.

In other embodiments, the catholyte scrubber has a scrubber input and a scrubber output, the scrubber input fluidly coupled to the cathode channel output to receive catholyte from the electrolytic cell, and the scrubber output fluidly coupled to the source reservoir to provide scrubbed catholyte to the source reservoir.

In another embodiment, the reservoir is in fluid communication with the cathode channel to provide source water from the reservoir to the cathode channel; and the catholyte scrubber has: a scrubber input coupled to the cathode channel output to receive catholyte from the electrolytic cell, and a scrubber output in fluid communication with the anode channel input to provide scrubbed catholyte to the anode channel of the electrolytic cell.

In yet another embodiment, a spray bottle apparatus for producing and dispensing ozonated water includes a body including a source reservoir configured to hold source water; a head including a nozzle for releasing ozonated water from the bottle; and an electrolytic cell disposed in fluid communication with the nozzle and the source reservoir and configured to ozonate water as the water flows from the source reservoir to the nozzle, the electrolytic cell having an anode channel having an anode channel output, and a cathode channel having a cathode channel output, the cathode channel fluidly isolated from the anode channel. The spray bottle apparatus also includes a source water scrubber disposed in fluid communication between the source reservoir and the electrolytic cell to produce scrubbed source water to the electrolytic cell.

In yet another embodiment, a spray bottle apparatus for producing and dispensing ozonated water includes: a body including a source reservoir configured to hold source water; a head including a nozzle for releasing ozonated water from the bottle; and an electrolytic cell disposed in fluid communication with the nozzle and the source reservoir and configured to ozonate water as the water flows from the source reservoir to the nozzle, the electrolytic cell having an anode channel having an anode channel input and an anode channel output, and a cathode channel having a cathode channel output, the cathode channel fluidly isolated from the anode channel. The spray bottle apparatus also includes a catholyte scrubber having a scrubber input and a scrubber output, the scrubber input fluidly coupled to the cathode channel output to receive catholyte from the electrolytic cell, and the scrubber output fluidly coupled to the anode channel input to provide scrubbed catholyte to the anode channel of the electrolytic cell. In some embodiments, the catholyte scrubber includes a charcoal scrubber.

### BRIEF DESCRIPTION OF THE DRAWINGS

The foregoing features of embodiments will be more readily understood by reference to the following detailed description, taken with reference to the accompanying drawings, in which:

FIG. 1A is a schematic view of an electrolytic cell used for the production of ozone that is used in the system for dispensing ozonated water in accordance with the embodiments discussed herein

FIG. 1B schematically illustrates an embodiment of a scrubber;

FIG. 1C schematically illustrates an embodiment of a scrubber;

FIG. 1D schematically illustrates an embodiment of a scrubber;

FIG. 2A is a view of the electrolytic cell shown in FIG. 1 with the addition of a switching valve to allow the output of the first and second flow paths from the electrolytic cell to be exchanged in order to allow switching of the electrodes from anode to cathode in order to reduce or prevent build-up of scale on the electrodes;

FIG. 2B is a view similar to FIG. 2A showing the switching of the electrodes from anode to cathode as well as switching of the outputs of the first and second flow paths;

FIG. 3A is a schematic view of a dispensing system using the electrolytic cell of FIG. 1A;

FIG. 3B is a cross-sectional view through a spray bottle that utilizes the electrolytic cell shown in FIG. 1 as well as the switching valve similar to that shown in FIG. 2B to provide a portable ozonated water delivery device;

FIG. 3C is a schematic view of a dispensing system for ozonated water that is part of a permanent installation that is connected to a water source such as a well or municipal water supply and delivers ozonated water through the outlet while the catholyte is discarded, such as being directed to a municipal or private drain system;

FIG. 4A is a schematic view of a dispensing system having separate anolyte and catholyte flow paths with the catholyte being recirculated from the electrolytic cell back to a catholyte reservoir;

FIG. 4B is a cross-sectional view through a spray bottle including separate anolyte and catholyte flow paths to and from the electrolytic cell in which the catholyte is reused similar to FIG. 4A;

FIG. 5A is a schematic view of a dispensing system for ozonated water in which the anolyte and catholyte are both discharged through an outlet and the catholyte is processed using a catholyte prior to remixing and discharge with the anolyte;

FIG. 5B is a cross-sectional view through a spray bottle which utilizes the arrangement of FIG. 5A along with a switching valve that is used in conjunction with switching of the electrodes between anode and cathode in order to prevent buildup of scale on the electrodes;

FIG. 6A is a schematic view of a dispensing system for ozonated water using the electrolytic cell of FIG. 1 in which the catholyte is processed by a catholyte scrubber prior to being recycled into the water source, which can be a tank in a portable spray bottle;

FIG. 6B is a cross-sectional view of a portable spray bottle in accordance with the system shown in FIG. 6A along with a switching valve that is used in conjunction with switching of the electrodes between anode and cathode in order to prevent buildup of scale on the electrodes;

FIG. 7A is a schematic view of an ozonated water dispensing system using the electrolytic cell shown in FIG. 1 which the catholyte is returned to the water source and water drawn from the water source to the electrolytic cell is processed by a source water scrubber prior to the water entering the electrolytic cell;

FIG. 7B is a portable spray bottle using the ozonated water dispensing system arrangement shown in FIG. 7A along with a switching valve that is used in conjunction with switching of the electrodes between anode and cathode in order to prevent buildup of scale on the electrodes;

FIG. 8 shows test data for ozone concentration decay over time for different amounts of power supplied to the electrolytic cell;

FIG. 9 is a table showing the decay rate of the ozone concentration per minute;

FIG. 10 is a chart showing a decay rate for ozonated water in which the anolyte was recombined with catholyte run through a carbon scrubber, RO water, or catholyte without scrubbing;

FIG. 11 is a table showing the decay rates of the ozone from the ozonated water discharges shown in FIG. 10;

FIG. 12 is a chart showing the ozone decay for combined ozonated water with water, carbon filtered catholyte, or catholyte which is unfiltered;

FIG. 13 is a table showing the decay rate of the ozone in the ozonated water discharges shown in FIG. 12;

FIG. 14 is a chart showing a decay rate for ozonated water in which the anolyte was recombined with source water, bubble trap (e.g., FIG. 1B; FIG. 1C) scrubbed catholyte, or catholyte which is unscrubbed;

FIG. 15A is a schematic view of another embodiment of an ozonated water dispensing system using the electrolytic cell shown in FIG. 1A;

FIG. 15B is a view similar to FIG. 15A showing the switching of the electrodes from anode to cathode as well as switching of the outputs of the first and second flow paths;

FIG. 16 schematically illustrates an embodiment of a chimney cell;

FIG. 17A schematically illustrates an embodiment of an ozonated water dispenser having a chimney cell;

FIG. 17B is a graph comparing ozone production and decay rate in a small (30 ml) bottle having a chimney cell to a small (30 ml) bottle having an electrolytic cell without a chimney.

### DETAILED DESCRIPTION OF SPECIFIC EMBODIMENTS

Various embodiments provide higher concentrations of ozone in ozonated water than was possible in prior art systems and methods. Various embodiments increase the efficiency of production of ozonated water by producing such higher concentrations of ozone in ozonated water using the same amount, or less, power than prior art systems and methods. Some embodiments enable production of water with higher concentrations of ozone, and/or ozonated water in which the concentration of ozone decays more slowly, as compared to prior art and methods. The inventors have found that embodiments achieve such results when the source water is tap water, and when the source water is distilled water.

### Definitions

The term “charcoal media” means a carbon-based media. In preferred embodiments, such a carbon-based media is a charcoal, examples of which are provided below.

A “current source” is an electronic circuit having a pair of output terminals that deliver or absorb a controlled electric current, wherein the quantity of the electric current is independent of the voltage across the output terminals. The current output of a current source is a controlled variable, and the voltage is an independent variable. In contrast to a current source, a battery is a voltage source, not a current source.

When a first feature is “fluidly isolated” from a second feature, liquid cannot flow directly from the first feature to the second feature.

When a first feature is in “fluid communication” with (or is “fluidly coupled” to) a second feature, liquid can flow from the first feature to the second feature, for example by a tube or conduit.

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

### An Electrolytic Cell

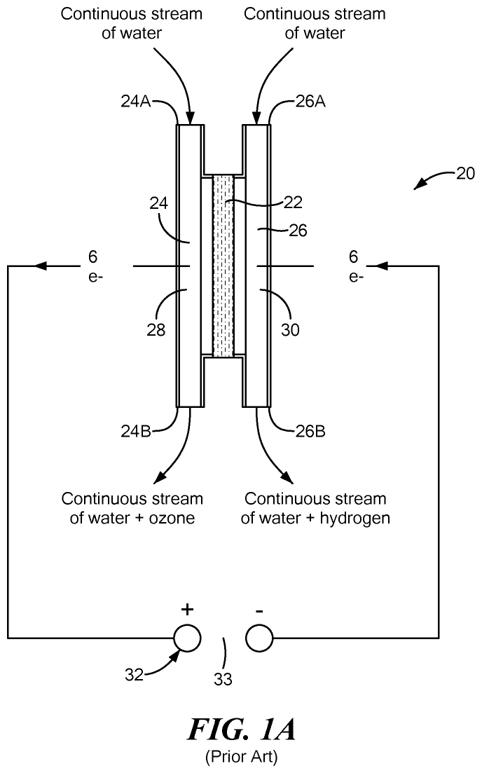

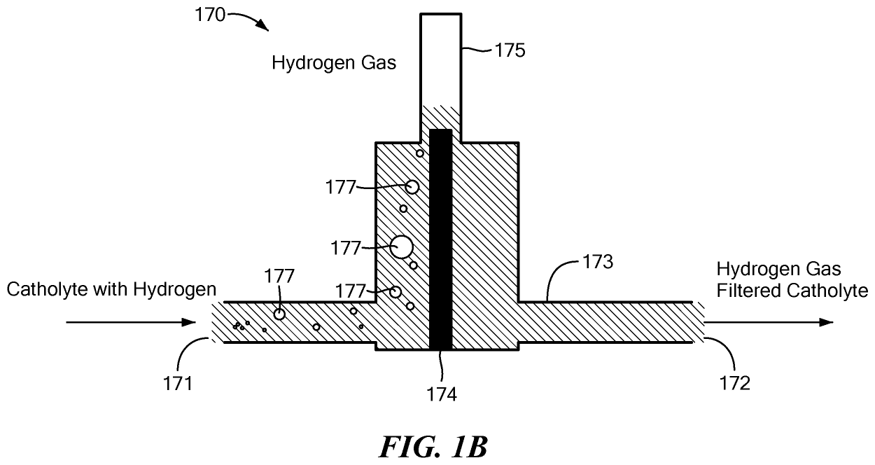

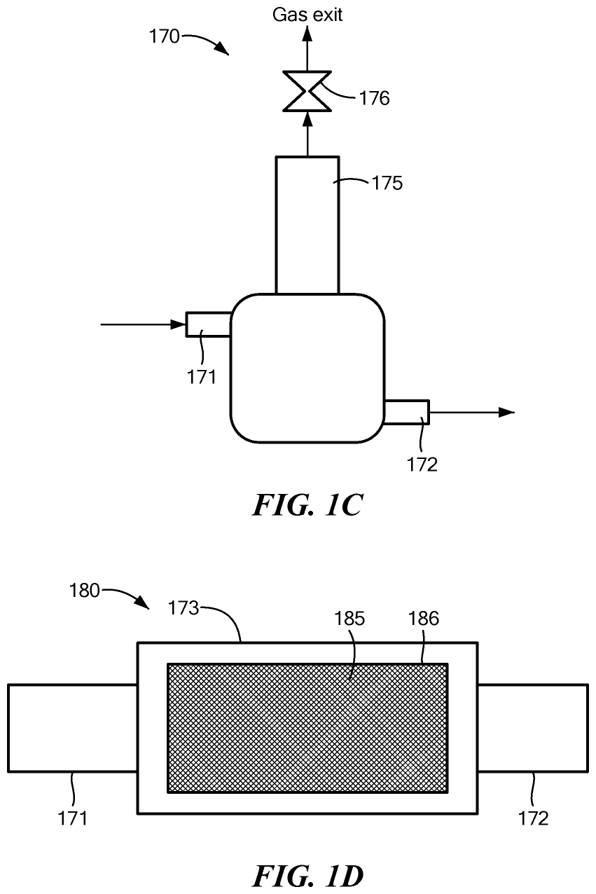

Referring to FIG. 1A, an electrolytic cell 20 that has a divided construction is shown. The electrolytic cell 20 is divided by a membrane 22 which is preferably a proton exchange membrane (PEM) such as Nafion®, and separates a first flow path 24 and a second flow path 26 from each other. A first electrode 28 is associated with and preferably forms a part of the first flow path 24, and a second electrode 30 is associated with and preferably forms part of the second flow path 26. The first flow path 24 includes an inlet 24A and discharges at a first flow outlet 24B. The second flow path similarly includes a second inlet 26A and discharges at a second flow outlet 26B. The first and second electrodes 28, 30 are connected via a power input 33 to a power source 32, which can be a DC transformer or a battery pack, which may include and/or provide power to a current source that drives the electrodes. As shown in FIG. 1A, a continuous stream of water is provided with sufficient pressure to flow into the first and second inlets 24A, 26A of the first and second flow paths 24, 26, respectively. The electrolytic cell 20 in the configuration shown generates ozone in the continuous stream of water discharged from the first flow outlet 24B on the side of the first electrode 28 which acts as an anode (the discharge being referred to as an anolyte), and generates excess H₂ in the water discharged from the second flow outlet 26B of the second flow path 26 where the second electrode 30 acts as a cathode (the discharge being referred to as a catholyte).

In order to achieve improvements in the ozonated water being discharged, several illustrative embodiments include the electrolytic cell 20 of FIG. 1A and provide improved performance with higher concentrations of ozone being available from the anolyte delivered from the first flow path 24.

### Scrubbers

Illustrative embodiments described herein include one or more scrubbers (170 and/or 180) in a fluid flow path. For example, a scrubber in the flow path of liquid catholyte may be referred to as a “catholyte scrubber,” and a scrubber in the flow path of liquid source water may be referred to as a “source water scrubber.”

One embodiment of a scrubber 170 is schematically illustrated in FIG. 1B, and may be referred to as a “bubbler” or “bubble trap.” Another embodiment of a similar scrubber 170 is schematically illustrated in FIG. 1C.

Some liquids, such as catholyte produced by an electrolytic cell 20, may include gaseous elemental hydrogen. Such gaseous elemental hydrogen may take the form of bubbles in the liquid, for example.

Each of the embodiments of FIG. 1B and FIG. 1C has a scrubber input 171 thorough which catholyte enters and a scrubber output 172 through which scrubbed liquid (e.g., source water and/or catholyte) exits. Each of those embodiments also includes a hydrogen release output 175 (which may include a ball valve 176).

As liquid (e.g., catholyte and/or source water) passes through the bubbler 170 from the bubbler input 171 to the bubbler output 172, it passes the hydrogen release output 175. Hydrogen bubbles 177 in the liquid tend to rise within the liquid and exit the liquid into the hydrogen release output 175, while the liquid flows to the bubbler output 172. Some embodiments include a diverter wall 174 within the bubbler 170, the diverter wall disposed to slow the flow of catholyte past the hydrogen release output 175, thereby facilitating release of hydrogen into the chimney 175. The liquid produced at the bubbler output 172 (which may be referred to as “scrubbed catholyte” or “scrubbed source water”) includes quantitatively less hydrogen than it did upon entering the bubbler, and in preferred embodiments includes substantially less hydrogen than it did upon entering the bubbler. Such a reduction of hydrogen gas in the liquid is beneficial because hydrogen in an ozone production device tends to destroy ozone produced by the device before the ozone can be dispensed or otherwise used.

Another embodiment of a scrubber 180 is schematically illustrated in FIG. 1D, and may be referred to as a “charcoal scrubber” 180. The charcoal scrubber 180 has a scrubber input 171 thorough which liquid (e.g., catholyte or source water) enters and a scrubber output 172 through which scrubbed liquid (scrubbed catholyte or scrubbed source water) exits. The charcoal embodiment of a cathode scrubber includes a carbon media 185 (or “charcoal” media).

As the catholyte passes through the charcoal embodiment 180 of the scrubber, the catholyte contacts and passes around and/or through the charcoal media 185 to become scrubbed catholyte. In preferred embodiments, the charcoal media 185 is contained within a container 186 that allows liquid to enter and contact the charcoal media, but also prevents particles of charcoal media 185 from being washed away in a liquid passing through the scrubber. In illustrative embodiments, the container 186 comprises porous polyethylene.

In preferred embodiments, the charcoal media comprises discrete pieces or particles of charcoal. Moreover, smaller-sized particles of charcoal are preferred over relatively larger sizes of charcoal. In preferred embodiments, the charcoal media is small bituminous coal with particles that have been screened through, or which would pass through, a mesh having 12×40 mesh size, and/or, particles having longest dimensions between 0.42 to 1.70 mm. In preferred embodiments, the charcoal media 185 comprises a small carbon media acquired from Selecto, Inc. of Suwanee, Ga., U.S.A.

In other embodiments, the media 185 is 12×40 mesh coconut shell granular activated charcoal, such as is available from Multavita of Dove Creek, Colo., U.S.A. In other embodiments, the media 185 is 12×50 mesh coconut shell granular activated charcoal, such as is also available from Multavita of Dove Creek, Colo., U.S.A.

Moreover, in preferred embodiments the charcoal media has been backwashed or acid washed (because the inventors have found that, in embodiments in which catholyte is recombined with the anolyte, if the charcoal media is not properly backwashed then dust may enter the catholyte and destroy or reduce the quantity of ozone in the anolyte).

In preferred embodiments, passage of catholyte through a charcoal scrubber (e.g., with acid washed charcoal) does not increase the pH of the catholyte. In general, preferred charcoal media 185 does not increase pH and preferably would decrease it.

In some embodiments, the charcoal embodiment 180 of a scrubber does not substantially remove hydrogen from catholyte that passes through the scrubber.

Note that each of the foregoing scrubbers (170; 180) is bidirectional, in that fluid may flow through the scrubber (170; 180) in either direction. Moreover, a scrubber (e.g., 380; 480; 480′; 480″) described in connection with various embodiments disclosed herein may include one of a bubble scrubber 170 and a charcoal scrubber 180, or both of a bubble scrubber 170 and a charcoal scrubber 180, for example arranged in series so that water flows through, and is scrubbed by, both.

### Reversing Electrical Polarity and Water Flow

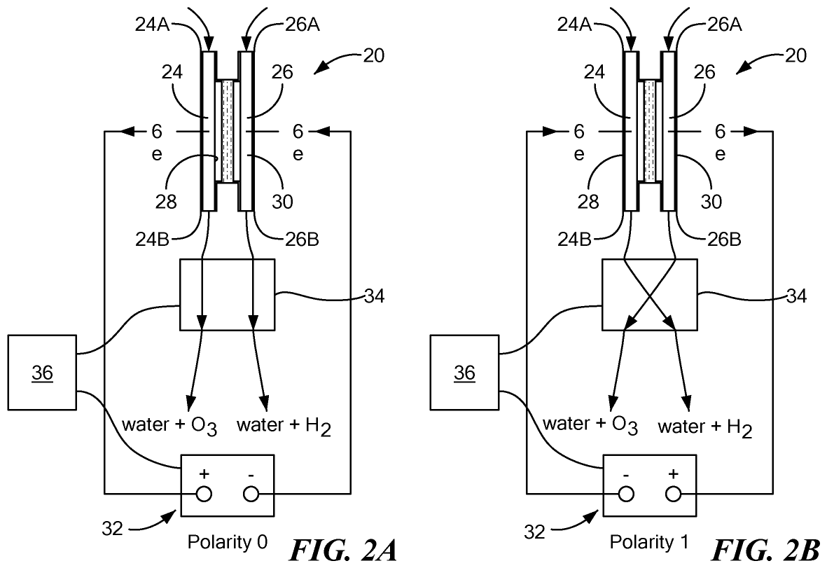

Referring to FIG. 2A, the arrangement of the electrolytic cell 20 is shown with, in this case, the power source 32 being able to switch polarity between the first and second electrodes 28, 30. In order to allow the downstream use of ozonated water to be directed in the required manner, a four-way valve, which can be for example a solenoid valve 34, is provided which allows for the connection of the first flow outlet 24B and the second flow outlet 26B to be switched such that the flow outlet of the overall system remains the same regardless of whether the first or second electrode 28, 30 acts as an anode. The four-way valve 34 as well as the reversing of the polarity of the connections from the power source 32 are preferably controlled via a controller 36. This arrangement addresses and mitigates buildup of scale on the electrodes due to impurities in the water by switching the power on a periodic basis.

FIG. 2B shows the arrangement in 2A with power source 32 and the valve 34 in the switched position such that the output of ozonated water from the second flow path 26B is still directed to the same ozonated water output from the system regardless of the polarity of the first and second electrodes 28, 30.

### Isolating Catholyte

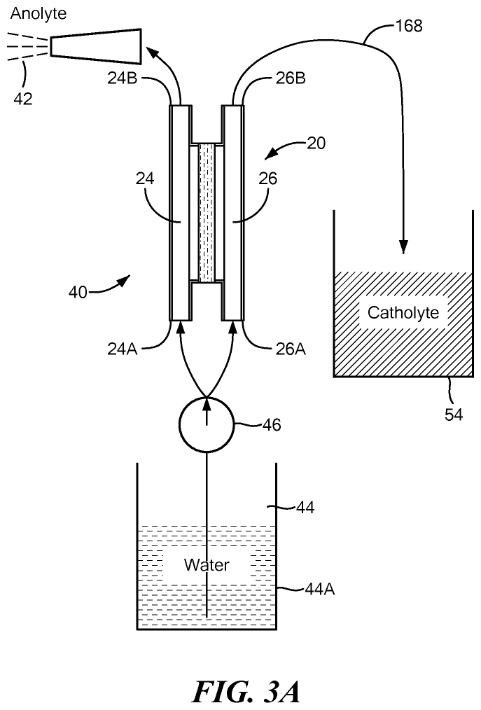

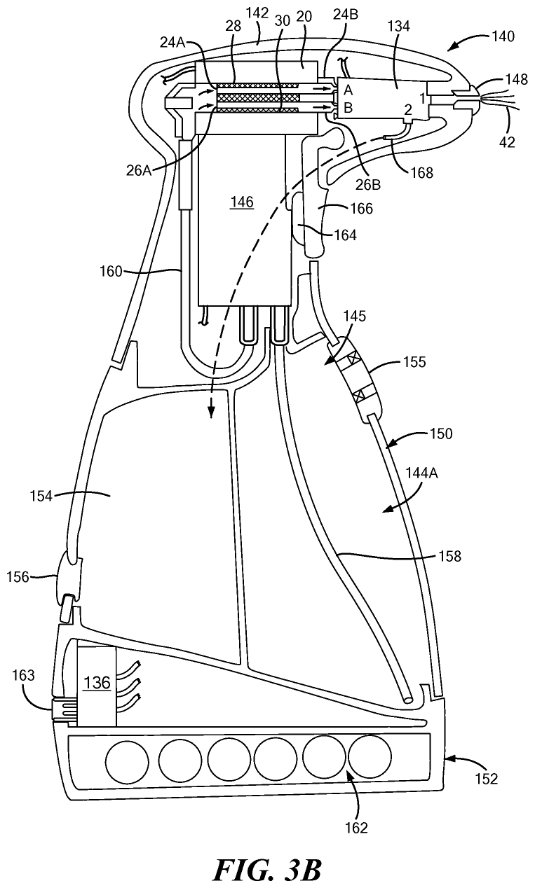

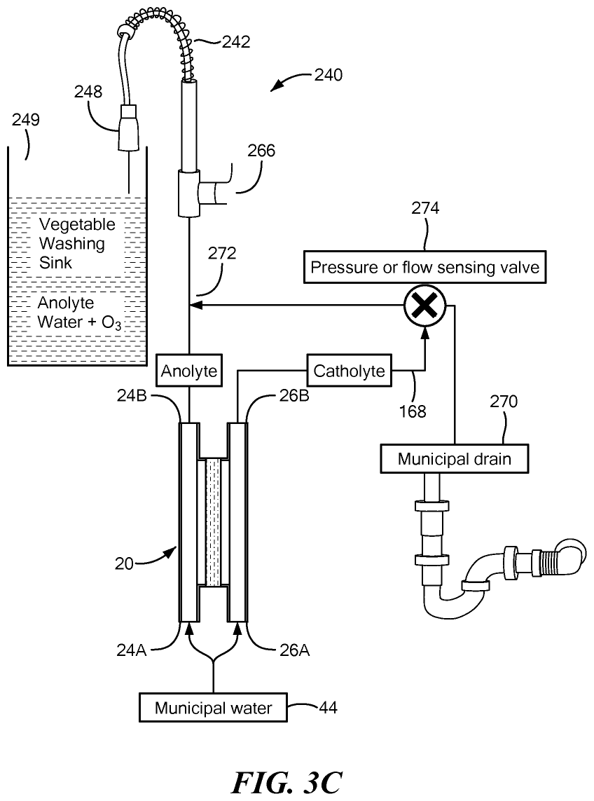

Referring now to FIG. 3A, a first embodiment of an ozonated water dispensing system 40 is shown schematically. A dispensing system 40 for dispensing ozonated water, indicated in dashed lines in 42 utilizes the electrolytic cell 20 described above in connection with FIG. 1. A switching valve 34 as shown in FIG. 2A and 2B can optionally be utilized. In the first embodiment of the dispensing system 40, the water source 44 is provided in the form of a tank 44A (or “reservoir”) and water from the tank 44A is delivered via a pump 46 to the first inlet 24A of the first flow path 24 and the second inlet 26A of the second flow path 26 of the electrolytic cell 20. Ozonated water from the first flow path 24 is directed via the first flow outlet 24B (e.g., via a conduit) to an outlet or nozzle 48 from which the ozonated water 42 is dispensed. Catholyte from the second flow outlet 26B which contains excess H₂ is directed to a second holding tank 54, as shown, or a drain. The electrolytic cell 20 is located between the outlet or nozzle 48 and the water source 44, with the electrolytic cell 20 being electrically coupled to power source (e.g., a current source), for example as shown in FIGS. 2A and 2B, which can be switched on along with the pump 46 when ozonated water 42 is desired. In this case. The first electrode 28 that forms a part of the first flow path 24 acts as the anode so that the ozonated water 42 is delivered through the first flow outlet 24B, and the second electrode 30 that forms a part of the second flow path 26 discharges at the second flow outlet 26B. Here, only one of the first or second flow outlets, in this case the first flow outlet 24B, is connected to the nozzle or outlet 48 and the other of the first or second flow outlets, in this case 26B, is one of connected to a storage tank, such as the second tank 54, or a drain. In further embodiments discussed below, the catholyte discharge can also be returned to the water source when it is in the form of a tank 44A rather than being a water main or municipal water source.

To the extent that the switching valve 34 of FIGS. 2A and 2B are utilized, this allows the first and second flow paths to switch between anolyte and catholyte flow paths while still delivering the anolyte (ozonated water 42) to the nozzle or outlet 48 and delivering the catholyte with the high H₂ concentration to second tank 50 or a drain so that it is discarded.

Referring to FIG. 3B, an embodiment of a practical application of the first embodiment of the dispensing system 40 is shown in the form of a spray bottle 140. The spray bottle 140 includes the electrolytic cell 20 mounted in the head 142. A nozzle 148 is also located in the head. As shown in FIG. 3B, preferably a switching valve 134 is also utilized and is similar to the switching valve 34 discussed above. This allows the first flow outlet 24B of the first flow path 24, connected at inlet A of the switching valve 134 to be connected to either the nozzle 148 via the switching valve outlet indicated at 1 or to a catholyte return line connection indicated at 2. Similarly, the second flow outlet 26B of the second flow path 26 connected at inlet B of the switching valve 134 can be connected to either a catholyte return line connection indicated at 2 or to the nozzle 148 via the switching valve outlet indicated at 1.

The spray bottle 140 includes a body 150 that is mounted on a base 152. The head 142 is connected at the top of the body 150. The body 150 and the head 142 can be formed integrally or as separate parts as shown. The base 152 is preferably formed as a separate part and connected to the body 150. The body includes a tank 144A (or “reservoir”) as the water source and also includes a second tank 154 in which catholyte is discharged. A water inlet 145 is provided for the tank 144A and is preferably closed via a plug 155. The second tank 154 which is used to collect the catholyte also includes a second plug 156 that is used to drain the catholyte from the second tank 154. A pump 146 having a feed line 158 connected to the inlet thereof, is used to draw water from the tank 144A and provide it to the first inlet 24A and the second inlet 26A of the electrolytic cell 20 via a pump discharge line 160. Both the pump 146 as well as the electrolytic cell 20 are powered via a battery pack 162 as the power source. A controller 136 is connected to a sensor 164 (e.g., a switch) that can be actuated by the user preferably via a trigger 166. Accordingly, when a user squeezes the trigger 166, it activates the sensor 164 which signals the controller 136 that ozonated water is being demanded. The controller 136 provides power from the battery pack 162 to the electrolytic cell 20 as well as the pump 146, which draws water from the water tank 144A via the feed line 158 connected to the pump inlet and discharges pressurized water via the pump discharge line 160 to the first and second inlets 24A, 26A of the first and second flow paths 24, 26 of the electrolytic cell 20 located in the head 142 of the spray bottle 140. Anolyte with ozone is delivered via the switching valve 134 to the nozzle 148 to be discharged while catholyte with excess H2 is delivered via the return line 168 to the second tank 154. The controller 136 can switch the electrodes 28, 30 between anode and cathode while at the same time changing the switching valve 134 so that the anolyte is always delivered to the nozzle 148 and catholyte is returned to the second tank 154.

In the preferred embodiment, the battery pack 162 is rechargeable and a charge connection 163 is provided. After the water tank 144 is empty, it can be refilled via the plug 155 and at the same time the catholyte from the second tank 154 can be drained via the plug 156.

Preferably, the head 142, body 150, and base 152 of the spray bottle 140 are made of polymeric materials and can be molded. While shown as separate parts that are connected together, for example using an adhesive, these may be integrally formed. Additionally, the plug 155 can include check valves to allow air to enter the water tank 144A as water is withdrawn via the pump 146 to prevent a vacuum lock.

Referring now to FIG. 3C, a permanently installed system for dispensing ozonated water 240 is shown. The system 240 operates using the same principles shown in connection with the first embodiment of the dispensing system 140 in FIG. 3A. Here, the electrolytic cell 20 is connected to a municipal water source 44 which provides pressurized water to the first inlet 24A and second inlet 26A of the first and second flow paths 24, 26. The first flow outlet 24B is connected to a faucet 242 which includes a discharge nozzle 248 as well as an on valve 266. A sensor 272 is connected to the flow path between the first flow outlet 24B and the control valve 266. The sensor 272 activates a solenoid valve 274 in order to allow catholyte discharge via the second flow outlet 26B to be discharged to a municipal drain 270. The sensor 272 can be a pressure or flow sensor. This can be used in connection with a sink in order to provide ozonated water from the first flow outlet 24B to the discharge nozzle 248, for example, for washing vegetables. However, the sink could be used for other purposes. While the power source for the electrolytic cell 20 is not shown, this could also be activated via the sensor 272 so that the electrolytic cell 20 is only powered when the control valve 266 is opened.

### Recirculating Catholyte

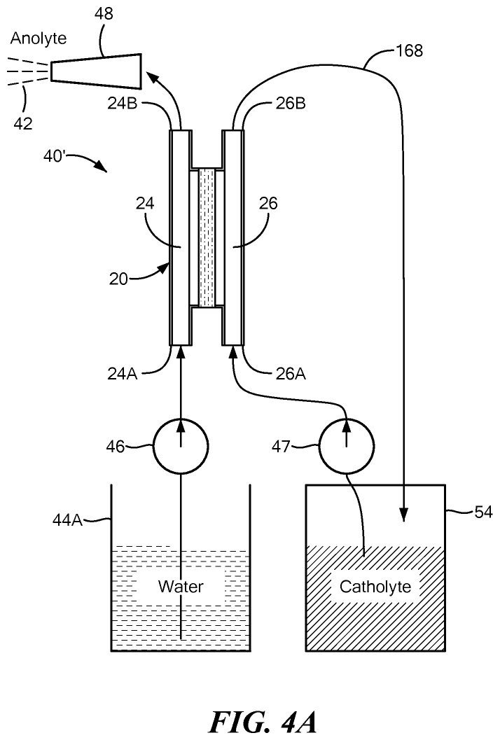

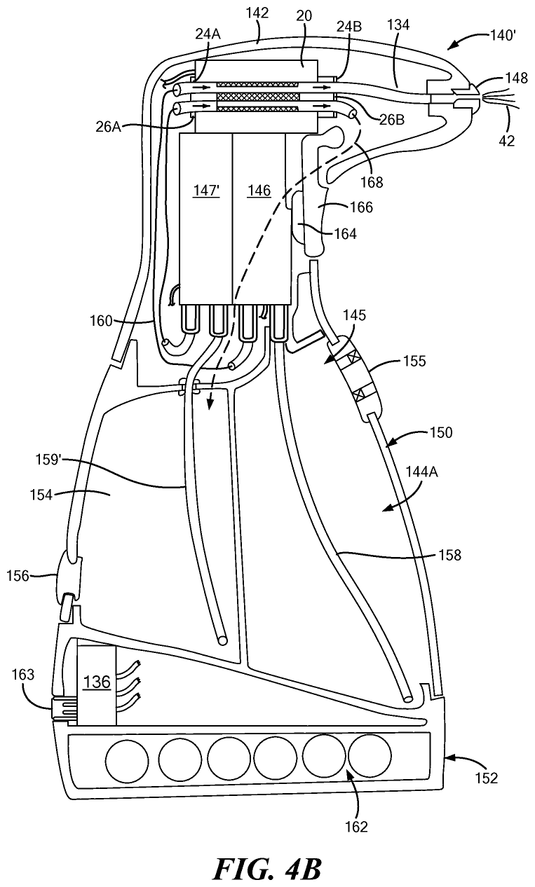

Referring to FIG. 4A, a second embodiment of a dispensing system 40′ is shown for discharging ozonated water. The second embodiment of the dispensing system 40′ is similar to the first embodiment 40 and that it uses the electrolytic cell 20 in the same manner as discussed above in connection with FIG. 3A. However, in this case rather than just discarding the catholyte from the second tank 54, a second pump 47 is provided and the first inlet 24A of the first flow path 24 is separated (fluidly isolated) from the second inlet 26A of the second flow path 26 into two separate flow circuits. In this case, the water from the tank 44A is fed via the first pump 46 to the first flow path 24 of the electrolytic cell 20 and ozonated water 42 is discharged via the nozzle or outlet 48 connected to the first flow outlet 24B of the first flow path 24. The flow through the second flow path 26 is in a separate circuit in which catholyte water is drawn from the second tank 54 via the second pump 47 and provided to the second inlet 26A of the second flow path 26 in order to allow ion exchange across the membrane 22. The H₂ which catholyte discharged from the second flow outlet 26B is returned to the second tank 54 for recirculation. In this case, the catholyte tank 54 can be drained and refilled at the same time that the tank 44A is refilled after it is emptied.

Referring to FIG. 4B, a spray bottle 140′ in accordance with the second embodiment of the dispensing system 40′ as shown in FIG. 4A is shown. The dispensing spray bottle 140′ is similar to the spray bottle 140. In this case, the switching valve 134 has not been used. In the spray bottle 140′, rather than merely returning the catholyte to the second tank 154, a second pump 147′ is provided along with a second feedline 159′ in order to create a second isolated circuit for the catholyte flow. The outlet from the second pump 147′ provides pressurized water/catholyte to the second inlet 26A of the second flow path 26 of the electrolytic cell 20. The catholyte discharged via the second flow outlet 26B of the second flow path 26 is returned to the second tank 154. In this case, the controller 136 which is actuated via the trigger 166 and the sensor 164 also actuates the second pump 147′ when a demand for ozonated water is sensed via a user actuating the trigger 166. The flow of water from the first tank 144A via the pump 146 and the pump discharge line 160 which is connected to the first inlet 24A of the first flow path 24 of the electrolytic cell 20 remains the same. The ozonated water 42 is delivered via the first flow outlet 24B to the nozzle 148 where it is discharged.

### Scrubbing Catholyte for Recombination with Anolyte

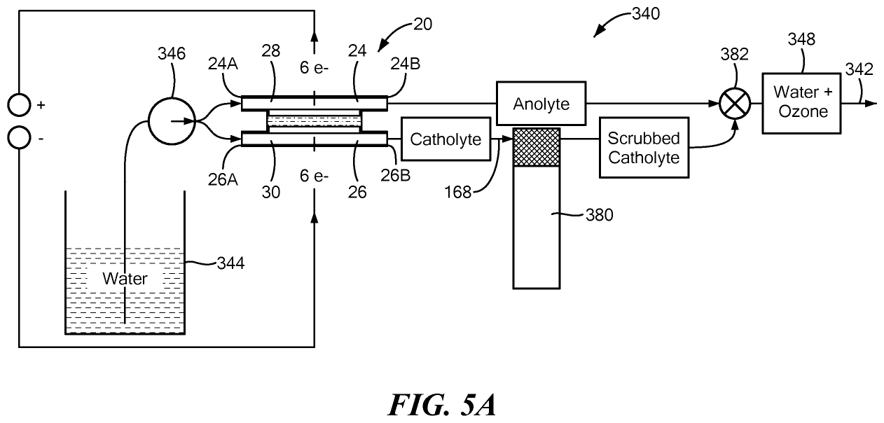

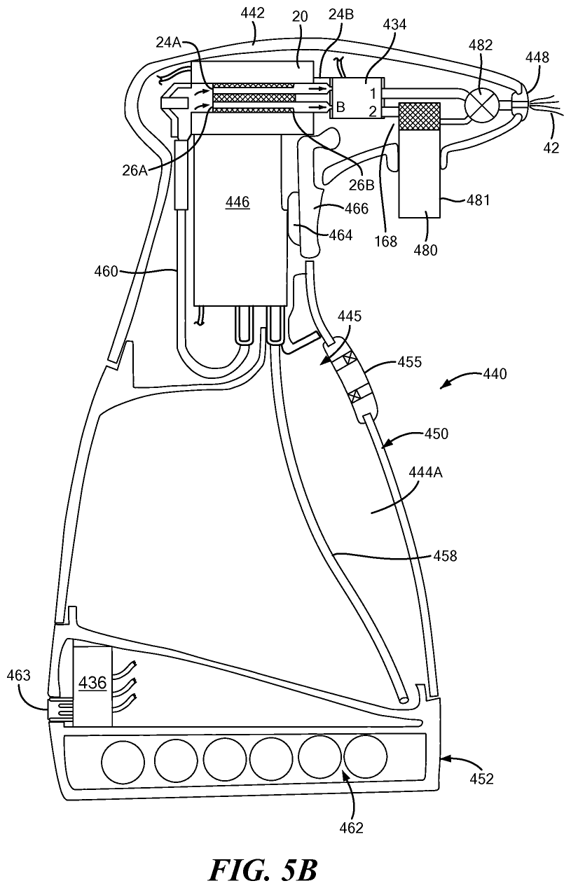

Referring now to FIG. 5A, a third embodiment of a dispensing system 340 is shown schematically. The third embodiment of the dispensing system 340 overcomes the issue of dealing with the catholyte via dispensing it through the outlet or nozzle 348 at the same time as the ozonated water as a discharge mixture 342. In this case, water is supplied from a water source 44 under its own pressure (such as a municipal water source) or via pump 46 to the electrolytic cell 20. Ozonated water generated in the first flow path 24 of the electrolytic cell 20 is delivered to the nozzle or outlet 348. Catholyte is delivered from the second flow outlet 26B of the second flow path 26 to a catholyte scrubber 380 (e.g., bubbler 170 and/or charcoal scrubber 180). The catholyte scrubber 380 preferably includes an activated carbon media; however, other scrubbers (e.g., H2 reducing scrubbers) can be used as discussed above. The scrubbed catholyte is delivered via a Y connection or mixing valve 382 with the flow of ozonated water from the first flow path 24 to the nozzle 348 and is discharged therewith. This arrangement provides a stream of ozonated water while at the same time eliminating the need for otherwise disposing of the catholyte. As discussed in detail further below, scrubbing of the catholyte with an activated carbon media (e.g., scrubber 180) and/or a bubbler 170results in an ozonated water stream in which the ozone concentration decays at about the same rate as ozonated water combined with fresh water.

Referring to FIG. 5B, an embodiment of a practical application of the third embodiment of the dispensing system 340 is shown in connection with a spray bottle 440. The spray bottle 440 has a similar construction to the spray bottle 140 and similar parts have similar reference numbers; however, the second tank 154 has been omitted, thereby allowing for a greater volume of water to be stored in the first tank 444A (or “reservoir”), and a catholyte scrubber 480 is located in the path between the catholyte outlet from the switching valve 434 and the Y connection or mixing valve 482 which combines the flow from the first flow path 24 of ozonated water with the scrubbed catholyte delivered from the second flow path 26 via the catholyte scrubber 480 to the Y connection or mixing valve 482 such that a mixture of ozonated water and scrubbed catholyte are delivered via the nozzle 448. As shown in FIG. 5B, the scrubber 480 preferably includes a charcoal medium (e.g., scrubber 180) and/or a bubbler 170 and can include a removable cartridge 481. Additionally, the switching valve 434, which operates in the same manner as the switching valve 134 discussed above, is used in conjunction with switching of the first and second electrodes 28, 30 to act as an anode or a cathode in order to prevent buildup of scale on the electrodes. The switching valve is disposed and configured to deliver catholyte to the scrubber 480.

The operation of the spray bottle 440 is similar to the operation of the spray bottle 140 in that activation of the trigger 466 causes the sensor 464 to signal the controller 436 to actuate the pump 446 which draws water through the feed line 458 from the tank 444A through the inlet of the pump and discharges water via the pump discharge line 460 to the first and second inlets 24A, 26A of the first and second flow paths 24, 26 of the electrolytic cell 20. Ozone rich anolyte is delivered to the nozzle 448 along with scrubbed catholyte via the switching valve 434 and the scrubber 480. The tank 444A can be refilled via the water inlet 445 which may be closed via a plug 455. Additionally, a battery pack 462 is provided as the power source for the controller 436, the pump 446, and the switching valve 434. A plug 463 is provided for recharging the battery pack 462. The spray bottle 440 is preferably formed with a head 442 in which the nozzle 448 is located along with a body 450 which includes the tank 444A as well as a base 452 in which the battery pack 162 as well as the controller 136 are located. As noted above in connection with the spray bottle 140, these can be formed of molded plastic parts.

As can be understood from the FIG. 5A and FIG. 5B, some embodiments provide a system (e.g., a water bottle) for generating ozonated water. Such systems include an electrolytic cell (20) having a cell input (24A, 24B) configured to receive water from a water source (344; 444A) and a power input (33) configured to receive electrical power from a power source. The electrolytic cell (20) includes an anode passage 24 in fluid communication with the cell input (24A), the anode passage including an anode (electrode 28) and an anode passage outlet (24B). The anode (electrode 28) is configured to produce ozonated water (the anode stream) at the anode passage outlet (24B). The electrolytic cell (20) also includes cathode passage (26) having a cathode (electrode 30), and a cathode passage outlet (26B), the cathode (electrode 30) configured to produce a cathode stream at the cathode passage outlet (26B). In preferred embodiments, the cathode passage outlet (26B) is fluidly isolated from the anode passage outlet (24B), such that the anode stream is fluidly isolated from the cathode stream. The system also includes an ozonated water output (e.g., a nozzle 48; 348; 448) in fluid communication with the anode passage output (24B), and a catholyte discharge conduit comprising a catholyte scrubber (e.g., 170 and/or 180; 380; 480) in fluid communication with the cathode passage output (24B) and configured to receive the cathode stream and to produce scrubbed catholyte.

In some embodiments the catholyte scrubber (e.g., 170 and/or 180; 380; 480) has an output in fluid communication with the ozonated water output to combine the scrubbed catholyte with the anolyte. Moreover, in some embodiments the catholyte scrubber (e.g., 170 and/or 180; 380; 480) has an output (172) in fluid communication with the mixing valve (382; 482), and the anode passage output (24B) is in fluid communication with the mixing valve (382), such that the scrubbed catholyte is mixed with the ozonated water in the mixing valve (382; 482), and the ozonated water output (448) is coupled to the anode passage output (24B) via the mixing valve (382; 482)), and the ozonated water output (448) is coupled to the cathode passage output (26B) via the catholyte scrubber (e.g., 170 and/or 180; 380; 480) and the mixing valve (382; 482).

### Scrubbing Catholyte for Recombination with Source Water

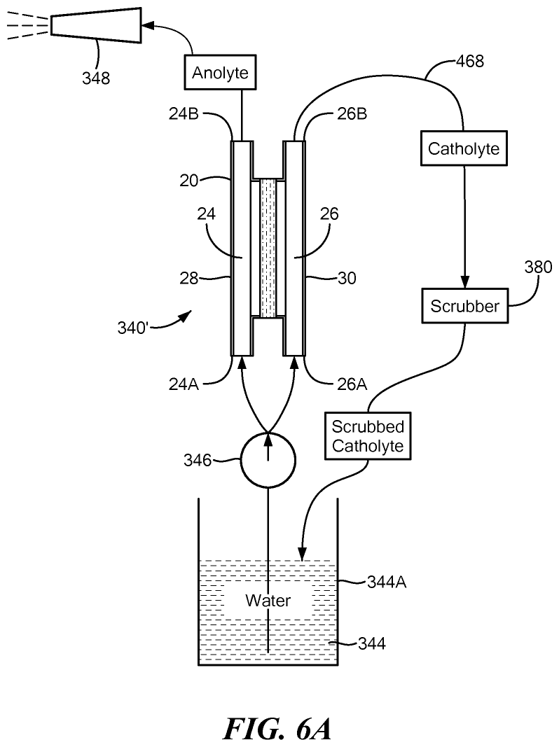

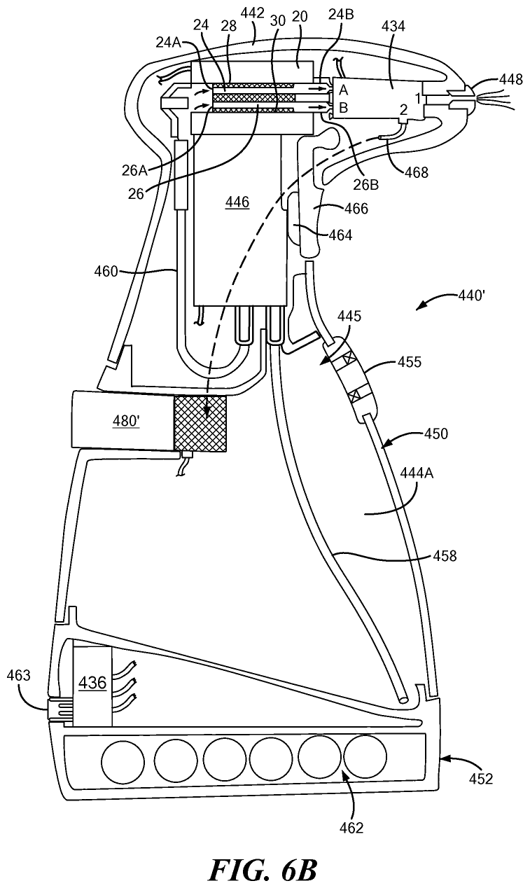

Referring to FIG. 6A, a schematic view of a fourth embodiment of a dispensing system 340′ is shown. The fourth embodiment of the dispensing system 340′ is similar to the third embodiment of the dispensing system 340 except that in this case rather than delivering the scrubbed catholyte to the outlet or nozzle 348, it is returned to the tank 344A. Accordingly, water from the source 344 is either delivered directly or via the pump 346 to the electrolytic cell 20 and the anolyte is delivered from the first flow outlet 24B of the first flow path 24 to the nozzle or outlet 348 where it is discharged. The catholyte discharged from the second flow outlet 26B of the second flow path 26 is delivered to the catholyte scrubber 380 and the scrubbed catholyte is then returned to the tank 344A. In some such embodiments, the catholyte scrubber 380 reduces an H₂ concentration in the catholyte.

Referring to FIG. 6B, an embodiment of a practical application of the fourth embodiment of dispensing system 340 is shown in connection with a spray bottle 440′. The spray bottle 440′ shown in FIG. 6B is similar to the spray bottle 440 shown in FIG. 5B. However, the scrubber 480′ is located in the return line 468 from the switching valve 434 which delivers the catholyte from the switching valve 434 back to the tank 444A such that scrubbed catholyte is returned to the tank 444A. Otherwise the function and structure of the spray bottle 440′ is the same as the spray bottle 440. As discussed in further detail below, returning the scrubbed catholyte to the water tank 444A has a greatly reduced effect on the ozone decay than returning unscrubbed catholyte to the water tank 444A.

As can be understood from the FIG. 6A and FIG. 6B, some embodiments provide a system (e.g., a water bottle) for generating ozonated water. Such systems include an electrolytic cell (20) having a cell input (24A, 24B) configured to receive water from a water source (344; 444A) and a power input configured to receive electrical power from a power source. The electrolytic cell (20) includes an anode passage (24) in fluid communication with the cell input (24A), the anode passage including an anode (electrode 28) and an anode passage outlet (24B). The anode (electrode 28) is configured to produce ozonated water (the anode stream) at the anode passage outlet (24B). The electrolytic cell also includes cathode passage (26) having a cathode (electrode 30), and a cathode passage outlet (26B), the cathode (electrode 30) configured to produce a cathode stream at the cathode passage outlet (26B). In preferred embodiments, the cathode passage outlet (26B) is fluidly isolated from the anode passage outlet (24B), such that the anode stream is fluidly isolated from the cathode stream. The system also includes an ozonated water output (e.g., a nozzle 48; 348; 448) in fluid communication with the anode passage output (24B), and a catholyte discharge conduit comprising a catholyte scrubber (e.g., 170 and/or 180; 380) in fluid communication with the cathode passage output (24B) and configured to receive the cathode stream and to produce scrubbed catholyte. The catholyte discharge conduit (168; 468) is in fluid communication with the water source (344) and is configured to deliver catholyte from the cathode passage outlet (26B) to the water source (344) downstream from the catholyte scrubber (380; 480′).

### Scrubbing Source Water

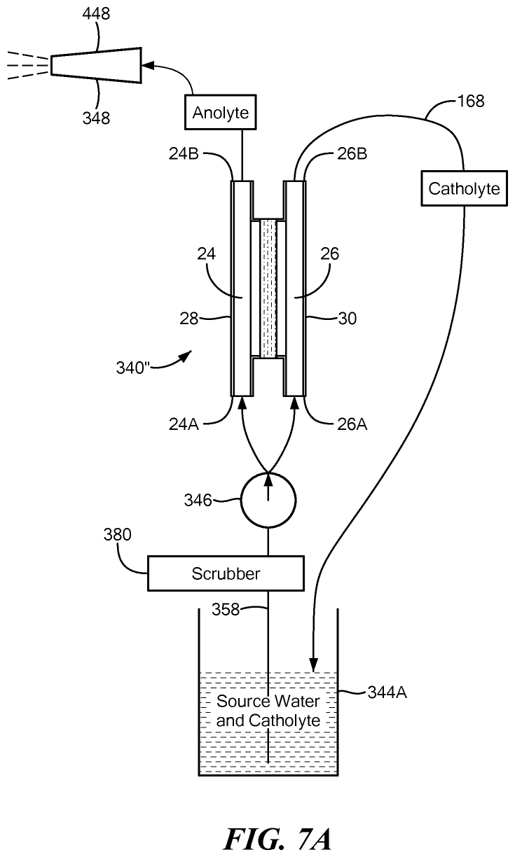

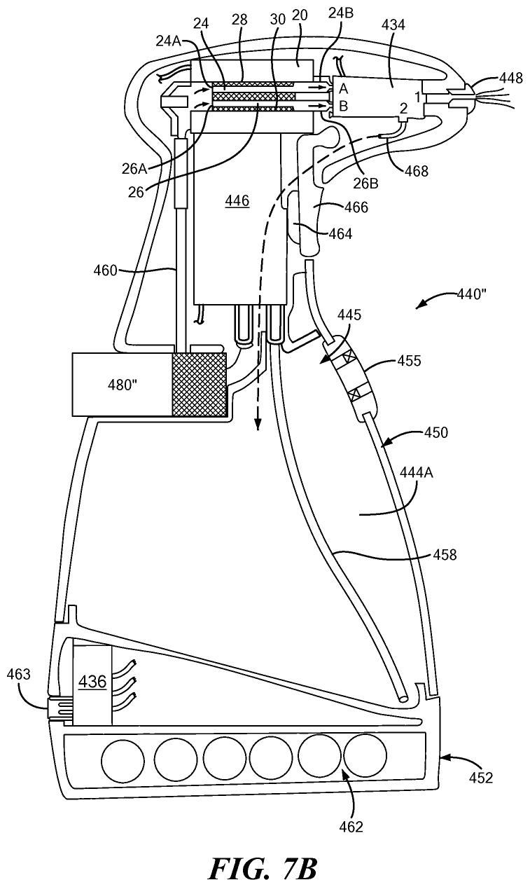

Referring now to FIG. 7A, a fifth embodiment of a dispensing system 340″ is shown schematically. The fifth embodiment of the dispensing system 340″ is similar to the fourth embodiment of the dispensing system 340′ except in this case the scrubber 380 is located in the feed line 358 from the tank 344A to the electrolytic cell 20. The pump 346 draws mixed water and catholyte from the tank 344A through the scrubber 380, which may include a charcoal scrubber 180 and/or a bubbler 170 for reducing H₂. The anolyte is delivered via the first flow outlet 24B of the first flow path 24 of the electrolytic cell 20 to the nozzle or outlet 348 where it is discharged. Catholyte with excess H2 from the second flow outlet 26B of the second flow path 26 is returned back to the water tank 344A. Here the processing by the scrubber 380 is of the mixed water and catholyte after the initial use. As in the prior embodiments, the scrubber 380 preferably includes an activated carbon scrubber which, as discussed in detail herein, greatly reduces the decay rate of the ozone in the ozonated water delivered from the nozzle 348.

Referring now to FIG. 7B, an embodiment of a practical application of the fifth embodiment of the dispensing system 340″ is shown in connection with a spray bottle 440″. The spray bottle 440″ is similar to the spray bottle 440′ and similar elements have the same reference numbers. However, in this case the pump 446 draws the mixed catholyte and water from the tank 444A through the scrubber 480″ (which may include a charcoal scrubber 180 and/or a bubbler 170 for reducing H2) so that a scrubbed water and catholyte mixture is delivered to the first inlet 24A of the first flow path and the second inlet 26A of the second flow path 26. In some embodiments, the switching valve 434 is used in conjunction with switching of the first and second electrodes 28, 30 to act as an anode or a cathode in order to prevent buildup of scale on the electrodes. The switching valve 434 ensures that the catholyte is returned to the tank 444A. The operation similar to that discussed above in connection with the fourth embodiment of the spray bottle 440′.

For the embodiments using a bubbler 170 and/or a charcoal scrubber 180, such scrubbing has been shown to substantially remove the hydrogen and other ozone destroying byproducts from the catholyte. This is not intuitive since carbon filtration is often used to destroy an ozone and including this in an electrolytic ozone cell is counterintuitive. In illustrative embodiments, in which catholyte is first run through a scrubber (170 and/or 180) and then recombined with the anolyte, the ozonated water produces has a two-four times initial ozone concentration in comparison to the situation where the catholyte is mixed directly with the anolyte. Further, the self-decay rate is substantially improved with catholyte that runs through the scrubber 380, 480 before being combined with the anolyte. As shown in the above embodiments, this approach can be used with or without the switching of the polarity of the electrodes 28, 30 using the controller and the down streaming switching valve 434.

With respect to the spray bottle arrangements, improvements were also seen by running the catholyte through the scrubber 380, 480 either before returning it to the tank or by recirculating it into the tank and then pulling all of the source water, including the catholyte through the scrubber 380, 480 before returning it to the electrolytic cell 20.

As discussed above, H2 reducing scrubbers (e.g. bubble traps) could also be used.

### Exemplary Data

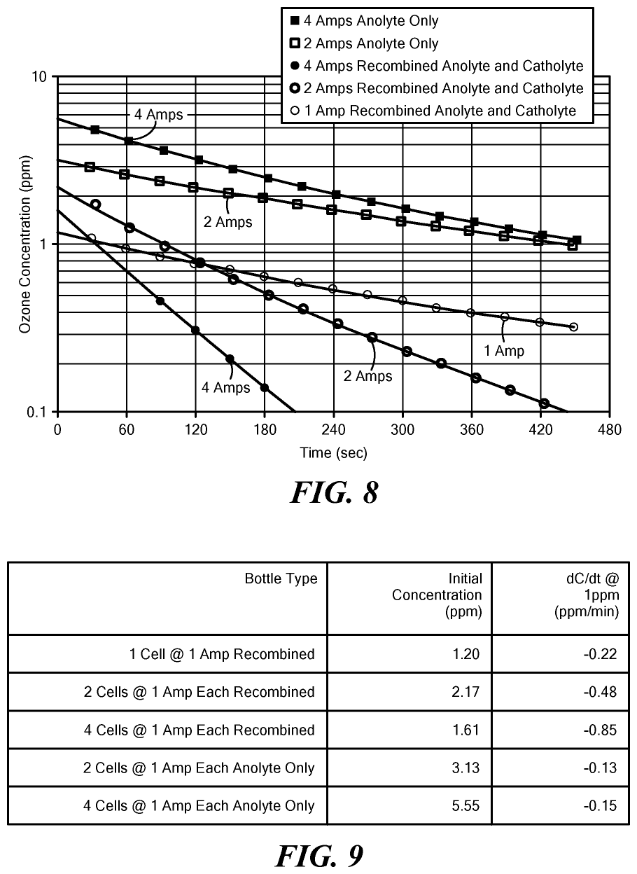

Referring to FIGS. 8 and 9, FIG. 8 shows a graph of ozone concentration decay rate over time for different power levels applied to the electrolytic cell 20 shown in FIG. 1. The 4 amp and 2 amp “Anolyte Only” show the best performance; however, they do not account for the catholyte. The 4 amp and 2 amp “Recombined Anolyte and Catholyte” graphs show a greater decay rate in ozone concentration. Notably, the 4 amp power applied to the electrolytic cell has a higher decay rate of the ozone concentration in the recombined anolyte and catholyte as compared to the 2 amp and 1 amp products, most likely due to the higher amount of free H₂ in the combined mix. FIG. 9 shows the initial concentrations and the decay rate per unit time.

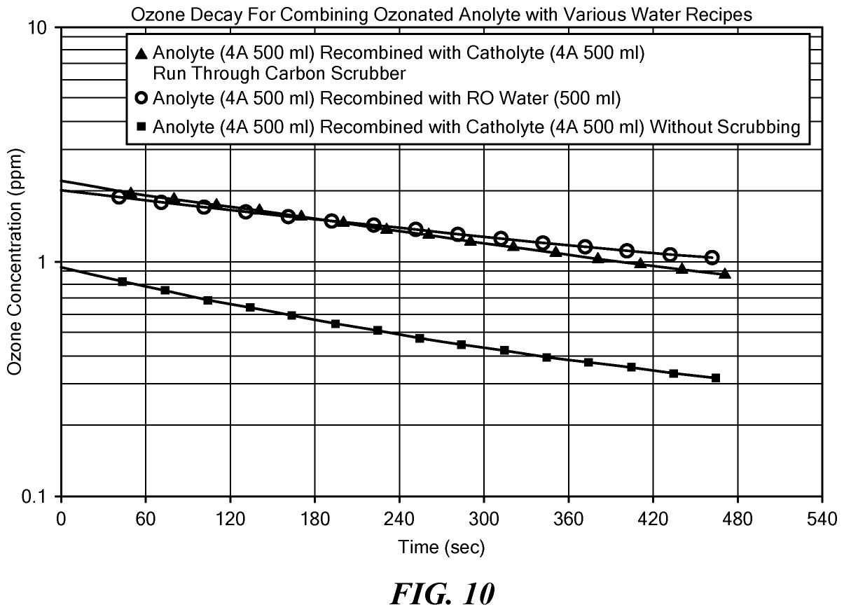

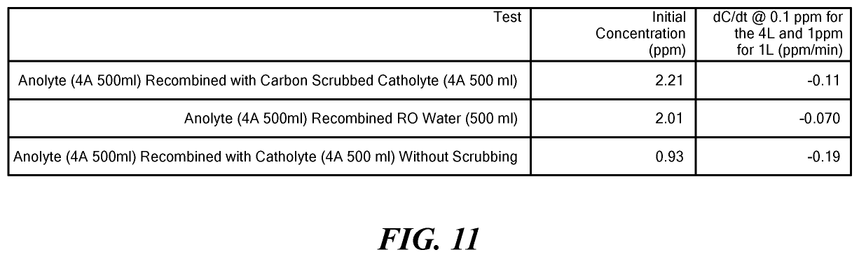

FIG. 10 and FIG. 11 show the ozone decay rate for combining ozonated anolyte with various different water recipes, in which the source water was reverse osmosis filtered water. It is noted that the decay rate for anolyte recombined with catholyte that was run through the carbon charcoal scrubber 480 has the same performance as anolyte recombined with fresh water (reverse osmosis filtered water to remove impurities). This is compared with anolyte recombined with catholyte without scrubbing which not only has a lower initial ozone concentration, but also a higher decay rate as shown at the bottom graph in FIG. 10. FIG. 11 also shows the initial concentrations and the decay rates per unit time for the three different combinations shown in FIG. 10. This supports the benefit of using the dispensing systems 340, 440 and 440′ in which the charcoal scrubber 380, 480 allow the catholyte that is scrubbed to be dispensed along with the anolyte, which is of particular benefit in a portable spray bottle arrangement such as 440. This allows the catholyte to be discharged so that it does not have to be separately stored or recirculated as in the embodiments of the dispensing system in the form of spray bottles 140, 140′ discussed above. Analogous improvement is provided for the spray bottle arrangements 440′ and 440″ in which the scrubbers 440′, 440″ are used to process catholyte that is recycled to the water reservoir.

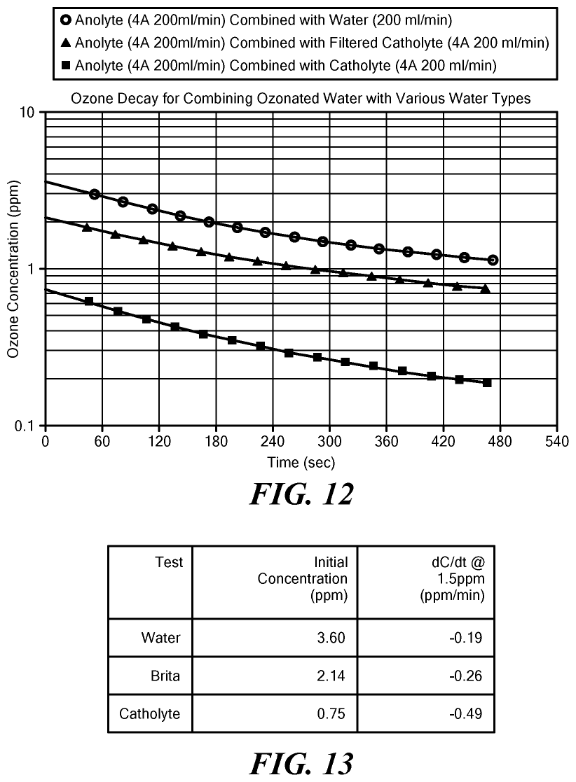

Referring now to FIG. 12 and FIG. 13, additional ozone decay rates for combining ozonated water with other water types, similar to FIGS. 10 and 11, is shown. The highest initial ozone concentration and lowest decay rate are shown with the anolyte combined with regular water. Additionally, a significant improvement is provided when the anolyte is combined with catholyte that is filtered through a commercially-available carbon filter in comparison to anolyte combined with unscrubbed catholyte. The filter included activated charcoal which, the inventors believe, provides this performance increase. The anolyte combined with catholyte has the lowest initial ozone concentration as well as the highest decay rate. The initial concentrations and the rate of decay are shown in FIG. 13.

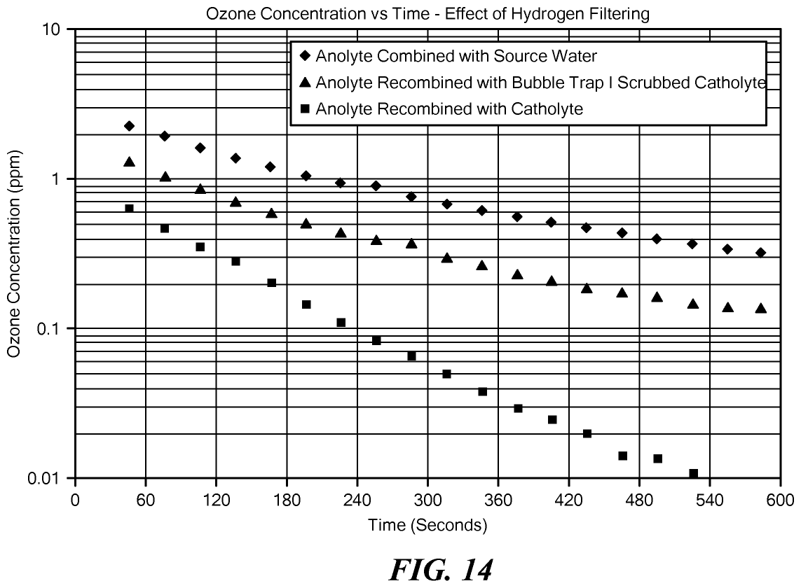

FIG. 14 shows additional ozone decay rates for combining ozonated water with other water types to illustrate the improvement provided by the bubble scrubber for removing excess H₂ shown in FIG. 1B and/or FIG. 1C. The highest initial ozone concentration and lowest decay rate are shown with the anolyte combined with regular water. Additionally, a significant improvement is provided when the anolyte is combined with catholyte that is processed through a bubble scrubber for removing H2 in comparison to anolyte combined with unprocessed catholyte. The anolyte combined with catholyte has the lowest initial ozone concentration as well as the highest decay rate.

In summary, dispensing systems 40, 140, 140′, 240, 340, 440, 440′, and 440″ are provided for producing ozonated water that has a lower decay rate than that previously provided. This is done in systems in which only the anolyte is discharged and the catholyte is either recirculated or discarded, or in systems in which the catholyte is either processed through a scrubber (e.g., a bubble trap) that reduces an H2 concentration in the catholyte prior to being recombined with the anolyte being discharged or processed through a charcoal scrubber prior to being recirculated back into the water tank or scrubbed by a scrubber in combination with water in the water tank prior to being drawn into the electrolytic cell. These arrangements can be used in both portable and fixed applications, such as spray bottles, 40′, 140′, 440, 440′, and 440″ or can be used in fixed applications such as a faucet/sink system 240. These arrangements can be used with or without switching valves in order to reverse the polarities of the electrodes between anode and cathode in order to prevent buildup of scale on the electrodes.

### Scrubbing Catholyte for Circulation to Anode

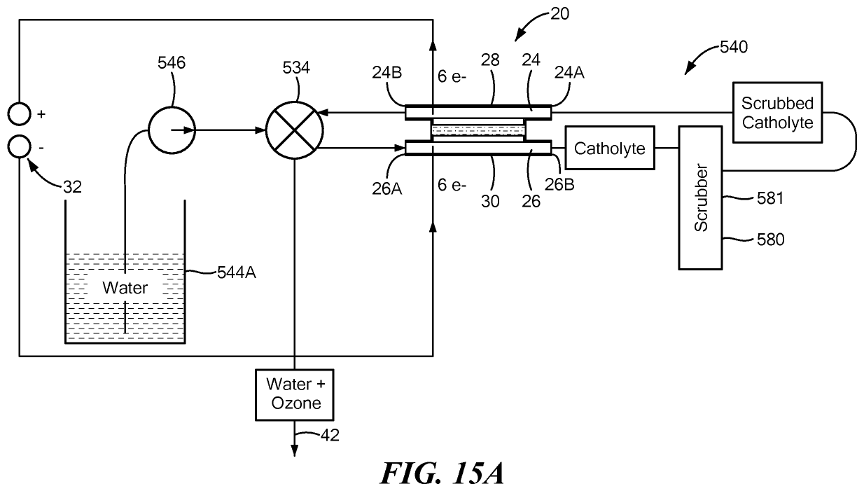

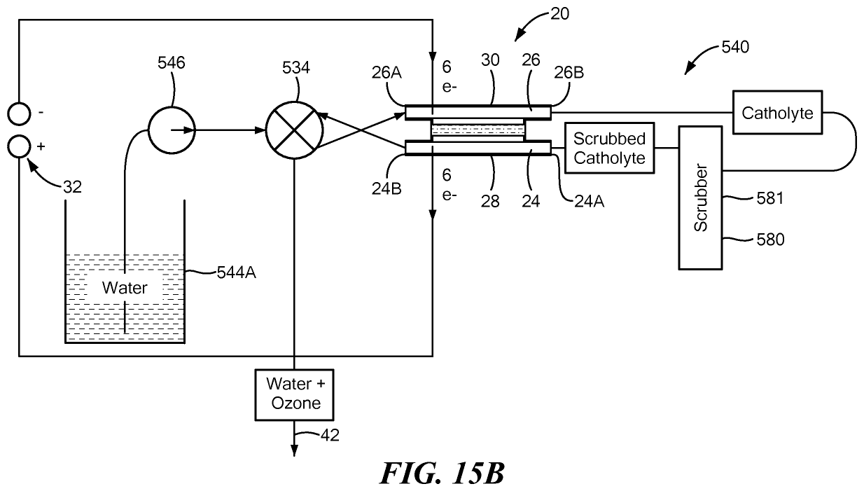

Referring now to FIGS. 15A and 15B, a further dispensing system 540 for producing ozonated water having a lower decay rate than previously available is provided. The system 540 utilizes the electrolytic cell 20 as discussed above. However, in contrast to all of the prior embodiments, all of the source water, for example from a tank 544A (or “reservoir”), is directed by a pump 546 or by pressure from the source (for example a municipal water system) to the second inlet 26A of the second flow path 26 (e.g., the cathode path), and the discharge of catholyte water that is rich in H2 from the second flow outlet 26B is fed to the scrubber 580 (which in some embodiments reduces the H2 concentration in the catholyte) and is then fed as scrubbed catholyte into the first inlet 24A of the first flow path 24 (the anode path). The first flow outlet 24B then discharges ozone rich anolyte. This system 540 avoids the need to store, discharge or otherwise process the catholyte separately and ensures that the full flow of water that is delivered to and from the electrolytic cell 20 is discharged as an ozone-rich anolyte.

In preferred embodiments, a switching valve 534 is used in conjunction with switching of the first and second electrodes 28, 30 to act as an anode or a cathode in order to prevent buildup of scale on the electrodes. The switching valve 534 is similar to the switching valve 34; however, it switches the inflow of water from the source between the second inlet 26A of the second flow path 26 (FIG. 15A) and what was the first outlet 24B of the first flow path 24 (see FIG. 15B) which becomes the second inlet 26A since the flow directions of the first and second flow paths 24, 26 through the electrolytic cell 20 in this embodiment are in opposite directions. This is done as a matter of convenience for arranging the water feed and discharge lines, and is not a requirement. Similarly, upon switching, the ozone rich anolyte is delivered from what was originally the second inlet 26A (FIG. 15A) which becomes the first outlet 24B (see FIG. 15B).

The scrubber 580 is similar to the scrubber 480 discussed above and preferably also uses a removable and replaceable cartridge 581.

The system 520 can be used in a spray bottle, similar to those discussed above, or could also be used in a permanent installation in a similar manner to the system 240; however, the system 540 eliminates the need to merely discharge catholyte down the drain.

### Chimney Cell

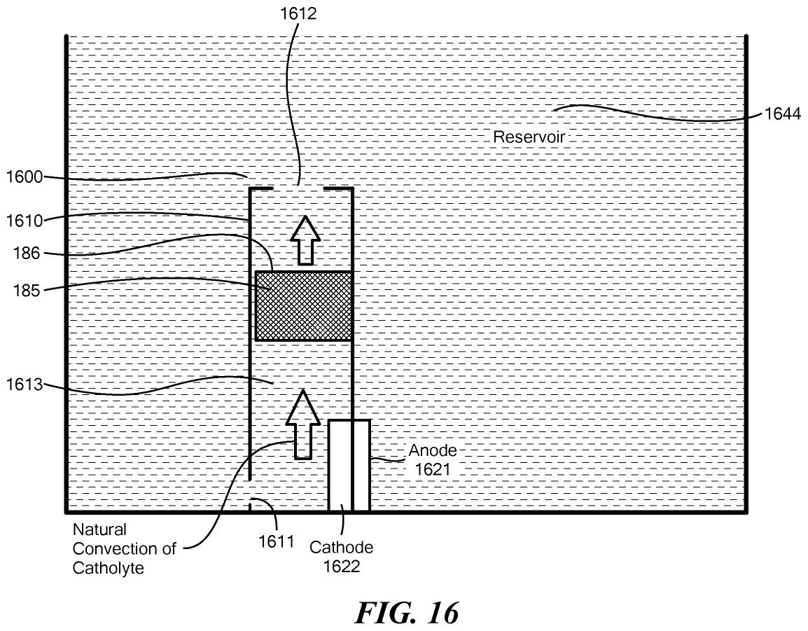

FIG. 16 schematically illustrates an embodiment of an electrolytic cell apparatus 1600, which may be referred to as a “chimney cell.” The chimney cell 1600 includes a chimney 1610 that defines a hollow chimney interior 1613. The chimney 1610 is a water-proof tube structure having an outlet aperture 1612. The chimney may have a cross-section that is circular (i.e., the chimney 1610 is a cylinder), but may have other shapes in cross-section as well. In preferred embodiments the chimney 1610 also has in inlet aperture 1611.

The chimney cell 1600 includes an anode 1621 and a cathode 1622. Illustrative embodiments omit a hydrogen-permeable (PEM) membrane between the anode 1621 and cathode 1622. The anode 1621 is disposed external to the chimney 1610 (e.g., outside of, or at least partially outside of, the chimney interior 1613) such that catholyte (including ozone) produced at the anode 1621 flows to the outside of the chimney 1610, into source water contained in the reservoir 1644, thereby producing ozonated water from the source water.

The cathode 1622 is disposed internal to the chimney 1610 (e.g., inside, or at least partially inside, the chimney interior 1613), such that catholyte (including hydrogen) produced at the cathode 1622 flows inside the chimney (i.e., into and within the chimney interior 1613).

The chimney cell 1600 also includes a charcoal media 185, as described above, disposed within the chimney interior 1613. The charcoal media 185 may be disposed adjacent to or around the cathode 1622, and/or between the cathode 1622 and the outlet aperture 1612. Hydrogen bubbles in the catholyte within the chimney interior cause a natural convection flow toward the outlet aperture 1612. In operation, catholyte flowing within the chimney interior 1613 flows to, and is scrubbed by, the charcoal media 185 to produce scrubbed catholyte. Preferred embodiments of the chimney 1610 include an inlet aperture 1611 disposed distal from the outlet aperture 1612, to allow source water to flow into the chimney near the cathode 1622, and thereby facilitate water flow into the chimney 1610, and catholyte flow within the chimney interior 1613.

The scrubbed catholyte exits the chimney 1610 at chimney outlet 1612, and mixes with the source water. The inventors have discovered through experimentation that the source water, having combined anolyte and catholyte from the chimney cell 1600, shows higher ozone concentration and slower decay rate as compared to ozonated water produced by an electrolytic cell submerged in source water in a reservoir 1644, but without a chimney 1610.

### Spray Bottle with Chimney Cell

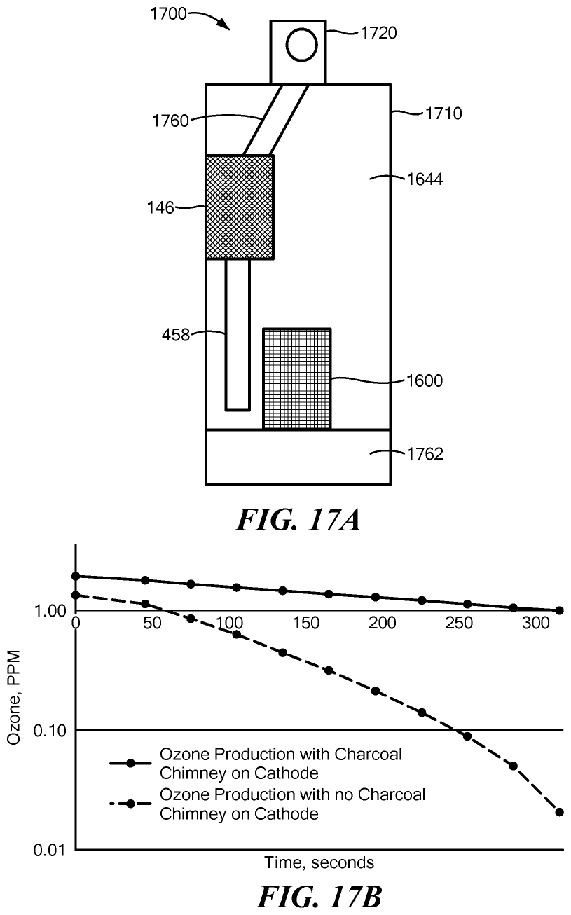

FIG. 17A schematically illustrates an embodiment of an ozonated water dispenser 1700 having a chimney cell 1600. FIG. 17B is a chart comparing ozone production and decay rate in a small bottle having a chimney cell to a small bottle having an electrolytic cell without a chimney.

The dispenser 1700 has a body 1710 that defines a water reservoir 1644. In preferred embodiments, the water reservoir has a volume of 30 ml, or less than or equal to 3 fluid ounces, although other embodiments may have a volume or more than or less than 30 ml, or 3 fluid ounces.

The dispenser 1700 also includes a spray outlet 1720 in fluid communication with the reservoir 1644 via conduit 1760. The spray outlet 1720 is disposed to dispense ozonated water from the reservoir 1644. In illustrative embodiments, the dispenser spray outlet 1720 includes a trigger (for example, trigger 166). Activation of the trigger 166 couples the anode 1621 and cathode 1622 of the chimney cell 1600 to a power source 1762.

In some embodiments, the spray outlet 1720 includes a manual pump as known in the spray bottle arts. Other embodiments of the dispenser 1700 include an electrically-power pump (for example, pump 146) in in fluid communication between the reservoir 1644 and spray outlet 1720. For example, the pump 146 may be in fluid communication with the spray outlet 1720 via conduit 1760, and may be in fluid communication with the reservoir 1644 via conduit 458. As such, the pump 146 may be described as being in fluid communication between the reservoir 1644 and the spray outlet 1720.

The pump 146 is operably coupled to the trigger 166 and power source 1762 to controllably drive ozonated water from the reservoir 1644 to the spray outlet 1720 in response to a user activation of the trigger 166.

A chimney cell 1600 is disposed within the water reservoir 1644, preferably near the bottom of the reservoir 1644. In preferred embodiments, the chimney cell 1600 is disposed at a portion of the dispenser 1700 distal from the spray outlet 1720. In operation, the chimney cell 1600 is submerged in source water within the reservoir 1644, and operates as described in connection with FIG. 16 to produce ozonated water within the reservoir 1644.

The dispenser 1700 also includes a source of electrical power 1762 to power the chimney cell, and a pump 146 if included it the dispenser 1700. In some embodiments, the source of electrical power 1762 is a battery compartment. In other embodiments, the source of electrical power 1762 is a power connector configured to receive electrical power from an external source.

The present inventors have discovered that the rate of self-decay of recombined anolyte/catholyte electrolytic ozone is dramatically affected by the target concentration. The higher the target concentration of ozone that is attempted to be made results in a higher self-decay rate that is attributable to a disproportionately higher amount of additional hydrogen available to react with the ozone. In fact, the inventors have discovered there is a limit beyond which adding more electrical current has the effect of creating less ozone instead of more. Further, even with a high overpotential electrode not all of the electrical current is used to create ozone.

The inventors have identified that there is a practical limit to electrolytic ozone concentration that can be produced by a recombined electrolytic cell using tap water. This limit is somewhat dependent upon other variables such as pH, temperature and other impurities in the water but in many applications it is difficult to make more than 2 ppm of dissolved ozone and even then the self-decay rate is substantially higher than if a lower concentration is made, so much so that when integrated over a 5 minute period a higher CT may be achieved with a lower current and initial concentration.

Based on these discoveries, a number of effective devices and methods are provided herein to effectively deliver a higher amount of dissolved ozone.

In one embodiment, an electrolytic cell receives source water in on each side, which is acted on by the electrodes and then delivers divided streams of anolyte and catholyte downstream of the cell.

The cell may use a switching polarity to prevent deposits from building up on the electrodes. For this arrangement, a valve is used downstream such that when the electrical polarity switches, the flows of the anolyte and catholyte are switched such that all downstream components are designed specifically to address either the anolyte or the catholyte. This can be carried out using a 4-way solenoid valve and the same logic and/or circuit that switches cell polarity can be used to switch the direction of water flow from the solenoid valve. Other valve arrangements may also be used.

In one arrangement, a portable device, such as a spray bottle, is provided that recirculates catholyte back into the source reservoir. This creates a situation where the recirculated catholyte is run back into the anode side of the cell and negatively impacts the ozone production for the rest of the source water in the tank. This problem only gets worse as the tank slowly drains the percentage of recirculated catholyte continues to increase. In order to address this issue, one solution is to add a second container that collects the catholyte. Water is put into the primary source reservoir and pumped up into both sides of the cell with a pump or other pressure generating device. Downstream of the cell in a single polarity configuration, the catholyte flow is immediately directed to a catholyte container and the anolyte is delivered out the nozzle of the spray bottle.

In another configuration where switching polarity is involved, a valve arrangement is provided downstream in order to direct the anolyte out the nozzle and the catholyte to the collection reservoir or drain.

For a portable device, when the source reservoir container in the bottle is refilled the catholyte collecting reservoir may be emptied at the same time.

In another portable embodiment, the bottle is configured with two separate pumping devices such that a dedicated catholyte solution is recirculated many times. These inexpensive portable embodiments allow that there is no limit to the ozone concentration that may be delivered from the nozzle.

These arrangements are not exclusive to portable devices, and can be used in more permanent installations, such as an ozonated water discharging sink having a similar divided flow out from an electrolytic cell. For example, the source reservoir and pump could be a municipal water supply or private well. Similarly, the catholyte collection reservoir could simply be a connection to a water waste line to a municipal or private sewer, storm drain etc. This is even more useful when combined with the switching polarity and valve arrangement.

In another aspect, the inventors have discovered that in some embodiments the hydrogen and other ozone destructing byproducts may be substantially removed from the catholyte by scrubbing (for example, via bubbler 170 to reduce the H2concentration). In some embodiments, carbon scrubbing is especially effective. This is contrary to conventional teachings, since in fact carbon filtration is often used to destroy aqueous ozone and the notion of putting even some of the output of an electrolytic ozone cell through a carbon filter at first would seem likely to be harmful. The inventors have discovered that catholyte first run through a carbon scrubber and then recombined with the anolyte will have 2-4 times of the initial ozone concentration as compared to the case where the catholyte is directly mixed with the anolyte. Moreover, the self-decay rate is substantially improved if the catholyte is run through a carbon scrubber before being combined with the anolyte. Other types of scrubbing, such as removing hydrogen through a degassing process could be used, such as a degasification filter or bubble trap. Other types of scrubbing for removing hydrogen can be, for example, through sparging, the use of a gas permeable membrane, or reverse osmosis (RO) filtration. Chemical filtration, such as a redox reaction filter could be used. For example, through the use of copper oxide could be used where the excess H₂ reacts with the CuO to form H₂O and Cu.

Carbon scrubbing can be used with or without the switching polarity of the electrodes and downstream valving.

Additionally the carbon scrubber can be used in connection with a spray bottle arrangement by running catholyte through the carbon scrubber before recombining and discharging the catholyte flow with the ozonated anolyte flow, by running catholyte through the carbon scrubber before returning it to the tank, or by recirculating into the tank and then pulling all source water including the catholyte through a carbon scrubber before returning it to the electrolytic cell. These solutions can also be combined with switching the polarity of the electrodes and using a valve arrangement as discussed above.

The carbon scrubbing can also be used in connection with a fixed arrangement, such as a sink faucet, if desired so that the catholyte is not merely discharged to a drain.

Additionally, in order to eliminate the need to separately process or discharge catholyte, the entire flow of source water can be fed to the cathode side flow path of the electrolytic cell, and the carbon scrubbing can be used on the catholyte discharge prior to feeding the entire scrubbed catholyte flow through the anode side flow path and discharging ozone rich anolyte.

A listing of certain reference numbers is presented below.

20: Electrolytic cell;

22: Membrane;

24: First flow path;

24A: First cell inlet;

24B: First cell outlet;

26: Second flow path;

26A: Second cell inlet;

26B: Second cell outlet;

28: First electrode;

30: Second electrode;

32: Power source;

33: Power input;

34: Solenoid valve;

36: Controller;

40: Embodiment of ozonated water dispensing system;

42: Ozonated water (e.g., anolyte water with ozone);

44: Water source;

44A: Tank (or reservoir);

46: Source water pump;

47: Catholyte recirculation pump;

48: Ozonated water output (e.g., nozzle);

54: Catholyte tank;

134: Switching valve;

136: Controller;

140: Spay bottle;

140′: Spray bottle;

142: Bottle head;

144A: Tank (or reservoir);

145: Water inlet to tank;

146: Source water pump;

147′: Catholyte pump (or “second pump”);

148: Nozzle;

150: Spray bottle body;

152: Spray bottle base;

154: Second tank (or “side stomach”)

155: Tank refill plug;

156: Second plug for second tank (or “drain plug”);

158: Source water feedline;

159′: Second feedline;

160: Discharge line;

162: Battery pack;

163: Batter charge connector;

164: Sensor (or switch);

166: Trigger;

168: Catholyte conduit (e.g., catholyte return line);

170: Bubbler scrubber:

171: Scrubber inlet;

172: Scrubber outlet;

173: Scrubber housing;

174: Bubbler wall;

175: Bubbler chimney;

176: Ball valve;

177: Bubble;

180: Charcoal scrubber;

185: Charcoal media;

186: Charcoal media container;

240: Ozonated water;

242: Faucet;

248: Discharge nozzle;

249: Sink;

266: On valve;

270: Municipal drain;

272: Valve sensor;

274: Valve (e.g., solenoid valve);

340: Third embodiment of a dispensing system;

340′: Fourth embodiment of a dispensing system;

342: Discharge mixture;

344: Water source;

344A: Tank (or “reservoir”);

346: Pump;

348: Outlet (or “nozzle”)

358: Tank-cell feedline;

380: Scrubber;

380′: Scrubber;

382: Mixing valve or Y connection;

434: Switching valve;

436: Controller;

440: Embodiment of a spray bottle;

440′: Embodiment of a spray bottle;

440″: Embodiment of a spray bottle;

442: Bottle head;

444A: Tank (or “reservoir”);

445: Tank fill inlet;

446: Pump;

448: Bottle nozzle;

450: Bottle body;

452: Bottle base;

455: Tank refill plug;

458: Tank-pump feedline;

460: Pump-cell feedline;

462: Battery pack;

463: Batter recharge plug;

464: Trigger sensor (or switch);

466: Pump-cell feedline;

468: Catholyte conduit (e.g., return line);

480: Scrubber;

480′: Scrubber;

481: Removable cartridge;

482: Mixing valve;

534: Switching valve;

540: Embodiment of dispensing system;

544A: Source water tank (or “reservoir”);

546: Pump;

580: Scrubber;

581: Replaceable cartridge.

1600: Chimney cell;

1610: Chimney;

1611: Chimney inlet aperture;

1612: Chimney outlet aperture;

1613: Chimney interior;

1621: Chimney cell anode;

1622: Chimney cell cathode;

1644: Source water reservoir;

1700: Small bottle dispenser;

1710: Small bottle body;

1720: Spray outlet;

1760: Spray outlet feed line;

1762: Small bottle power source.

Various embodiments may be characterized by the potential claims listed in the paragraphs following this paragraph (and before the actual claims provided at the end of this application). These potential claims form a part of the written description of this application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public.

Without limitation, potential subject matter that may be claimed (prefaced with the letter “P” so as to avoid confusion with the actual claims presented below) includes:

P1. A system for dispensing ozonated water, the system comprising: a water source; a current source having a current output; a nozzle for releasing ozonated water from the system; an electrolytic cell located between the nozzle and the water source, the electrolytic cell electrically coupled to the current output and having a first electrode that forms a part of a first flow path and discharges at a first flow outlet, and a second electrode that forms a part of a second flow path and discharges at a second flow outlet; and only one of the first or the second flow outlets is connected to the nozzle and the other of the first or the second flow outlets is one of: (a) discarded; (b) connected to the water source, or (c) connected to a storage tank.

P2. The system of P1, wherein the first electrode is an anode and the second electrode is a cathode, and the first flow path discharges ozonated water to the nozzle.

P3. The system of P1, further comprising: a controller configured to reverse the polarity of the first and the second electrode, and a valve arrangement connected to the controller that switches the connection of the first flow outlet and the second flow outlet such that the flow outlet of the first or second electrode that acts as an anode is connected to the nozzle.

P4. The system of P1, wherein the water source is a tank and the other of the first or the second flow outlets is connected to the tank, and the system further comprises a filter (for example, a bubble trap 170 that reduces an H₂ concentration in a catholyte, or charcoal scrubber 180) located in a flow path between the other of the first or second flow outlets and the tank.

P5. The system of P4, further comprising: a pump for delivering the water from the tank to the electrolytic cell.

P6. A system for dispensing ozonated water, the system comprising: a first tank having an interior for containing water; a second tank (a catholyte reservoir) having an interior for containing water (e.g., catholyte); a current source having a current output; a nozzle for releasing ozonated water from the system; and an electrolytic cell coupled to the current output and having an anode that forms a part of a first flow path and discharges at a first flow outlet, with the first tank being connected to an input of the first flow path to supply ozonated water to the nozzle, and a cathode that forms a part of a second flow path and discharges at a second flow outlet, with the second tank being connected to an input of the second flow path, and the second flow outlet is connected to the second tank.

P7. The system of P6, further comprising a first pump that delivers water from the first tank to the input of the first flow path, and a second pump that delivers water from the second tank to the input of the second flow path.

P8. A system for dispensing ozonated water, the system comprising: a water source; a current source having a current output; an outlet for releasing ozonated water from the system; an electrolytic cell located between the outlet and the water source, the electrolytic cell electrically coupled to the current output and having a first electrode that forms a part of a first flow path and discharges at a first flow outlet, and a second electrode that forms a part of a second flow path and discharges at a second flow outlet; and a filter (for example, a bubble trap 170 that reduces an H₂ concentration in a catholyte, or charcoal scrubber 180) connected in at least one of (a) a feed path between the water source and the first and the second flow inputs, (b) a first discharge path between one of the first or the second flow outlets and the outlet, (c) a second discharge path between one of the first or the second flow outlets and the water source, or (d) a flow path located between the second flow outlet and a first inlet of the first flow path.

P9. The system of P8, wherein the filter is a charcoal filter.

P10. The system of P8, wherein the water source is a tank.

P11. The system of P8, wherein the first electrode is an anode and the second electrode is a cathode.

P12. The system of P11, wherein the filter is connected in the first discharge path between the second flow outlet and the nozzle or in the second discharge path between the second flow outlet and the water source.

P13. The system of P8, further comprising: a controller that reverses a polarity of the first and the second electrodes, and a valve arrangement connected to the controller that switches the connection of the first flow outlet and the second flow outlet such that the flow outlet of the first or second electrode that acts as a cathode is connected to the filter.

P14. The system of P8, wherein the filter is located in the first discharge path between the one of the first or the second flow outlets and the nozzle, and the other of the first or the second flow outlets delivers ozonated water to the nozzle.

P15. The system of P8, wherein the charcoal filter is located in the feed path between the water source and the first and the second flow inputs, and the one of the first or second flow outlets from the one of the first or the second electrodes that acts as an anode is connected to the nozzle.

P16. The system of P15, wherein the one of the first or the second flow outlets from the one of the first or second electrodes that acts as a cathode is connected to a tank acting as the water source.

P17. The system of P8, wherein the filter is located in the second discharge path between one of the first or the second flow outlets and the water source, and the one of the first or second flow outlets from the one of the first or the second electrodes that acts as an anode is connected to the nozzle.

P18. The system of P8, wherein the water source is connected to a second inlet of the second flow path, and the filter is located in the flow path located between the second flow outlet and the first inlet of the first flow path, and the outlet for releasing ozonated water is connected to the first outlet, such that all water from the water source is directed to the second inlet.

P19. A system for dispensing ozonated water, the system comprising: a water inlet; a current source having a current output; an outlet for releasing ozonated water from the system; an electrolytic cell located between the outlet and the water inlet, the electrolytic cell electrically coupled to the current output and having a first electrode that forms a part of a first flow path and discharges at a first flow outlet, and a second electrode that forms a part of a second flow path and discharges at a second flow outlet; and only one of the first or the second flow outlets is connected to the outlet and the other of the first or the second flow outlets is connected to a drain.

P20. The system of P19, wherein the first electrode is an anode and the second electrode is a cathode, and the first flow path discharges ozonated water to the outlet.

P21. The system of P19, further comprising: a sensor connected to the first flow path and a valve connected to the second flow path that opens in response to a signal from the sensor.

P22. The system of P19, further comprising: a controller that reverses the polarity of the first and the second electrode, and a valve arrangement connected to the controller that switches the connection of the first flow outlet and the second flow outlet such that the flow outlet of the first or second electrode that acts as an anode is connected to the outlet.

P23. A method for operating an electrolytic cell to produce ozonated water, the method comprising: providing a flow of water to an electrolytic cell having a first electrode that forms a part of a first flow path and discharges at a first flow outlet, and a second electrode that forms a part of a second flow path and discharges at a second flow outlet; providing a positive current to one of the first electrode or the second electrode to form an anode and discharging ozonated water from the respective one of the first flow outlet and the second flow outlet; and providing a negative current to the other of the first electrode or the second electrode to form a cathode and discharging hydrogen rich water from the respective one of the first flow outlet or the second flow outlet; and one of (a) discharging the hydrogen rich water or (b) directing the hydrogen rich water through a filter that reduces an H₂ concentration in a catholyte prior to discharging with the ozonated water or re-cycling with the flow of water to the electrolytic cell.

P24. The method of P23, further comprising: providing a controller that reverses a polarity of the first and the second electrodes, and a valve arrangement connected to the controller; and the controller activating the valve arrangement and switching the connection of the first flow outlet and the second flow outlet such that the flow outlet of the first or second electrode that receives the negative current and acts as a cathode is connected to the filter.

P25. The method of P23, wherein the filter is a filter that absorbs hydrogen.

P26. The method of P23, wherein the filter is a charcoal filter.

P27. The method of P23, wherein the filter is a degasification filter (e.g., a bubbler 170).

P28. The method of P23, wherein the filter is a redox reaction filter.

P31: A chimney cell (1600) comprising: a chimney defining an interior volume, and having an outlet aperture to allow flow of fluid from the interior volume out of the chimney; an electrolytic cell having an anode and a cathode, the cathode disposed within or at least substantially within the interior volume of the chimney such that hydrogen produced at the cathode flows into and through the interior volume of the chimney, and the anode disposed external to or at least substantially external to the interior volume of the chimney, such that anolyte produced at the anode flows external to the interior volume of the chimney to ozonate water adjacent to the anode.

P32: The chimney cell of P31 wherein the chimney further includes an inlet aperture to allow flow of source water into the interior volume of the chimney.

P33: The chimney cell of P32 wherein the inlet aperture is disposed at an end of the chimney distal from the outlet aperture.

P34: The chimney cell of P31 wherein the cathode is disposed entirely within the interior volume of the chimney.

P35: The chimney cell of P31 wherein more than 50% of the cathode is disposed within the interior volume of the chimney.

P36: The chimney cell of P31 wherein the anode is disposed entirely external to the interior volume of the chimney.

P37: The chimney cell of P31 wherein more than 50% of the anode is disposed external to the interior volume of the chimney.

P41: A spray bottle for generating and dispensing ozonated water, the spray bottle comprising: a body defining a reservoir; a chimney cell disposed within the reservoir; a spray outlet in fluid communication with the reservoir to receive ozonated water from the reservoir and dispense the ozonated water.

P42: The spray bottle of P41, further comprising a power source.

P43: The spray bottle of P42, wherein the power source includes a battery pack.

P44: The spray bottle of P42, wherein the power source includes an electrical connector configured to receive electrical power from a source external to the spray bottle.

P45: The spray bottle of any of P41-P44, wherein the spray outlet includes an electrical trigger which, when activated by a user, causes a power source to provide electrical power to the electrolytic cell.

P46: The spray bottle of any of P41-P45, wherein the electrical trigger which, when activated by a user, causes a power source to provide electrical power to a pump in fluid communication between the reservoir and the spray outlet.

P47: The spray bottle of any of P41-P45, wherein the spray outlet includes a manual pump.

P48: The spray bottle of any of P41-P47, wherein the reservoir has a volume of less than or equal to 30 ml.

P49: The spray bottle of any of P41-P47, wherein the reservoir has a volume of less than or equal to 3.0 fluid ounces.

P51: An apparatus (e.g., a spray bottle) for producing and dispensing ozonated water, comprising: a source reservoir (44A; 144A) configured to hold source water and catholyte reservoir (54; 154) configured to receive and hold catholyte; a head comprising a nozzle (148) for releasing ozonated water from the apparatus (e.g., bottle); and an electrolytic cell (20) disposed in fluid communication with the nozzle (148) and the source reservoir (44A; 144A) and configured to ozonate water as the water flows from the source reservoir (44A; 144A) to the nozzle (148), the electrolytic cell (20) having: an anode channel (24) having an anode channel input (24A), and an anode channel output (24B) in fluid communication with the nozzle (148), and a cathode channel (26) having a cathode channel input (26A) and a cathode channel output (26B), the cathode channel output (26B) in fluid communication with the catholyte reservoir (54; 154) to provide catholyte from the electrolytic cell (20) to the catholyte reservoir (54; 154). {see, e.g., FIG. 3A; FIG. 3B; FIG. 4A; FIG. 4B}

P52: The apparatus (spray bottle) of P51, wherein the catholyte reservoir (54; 154) is in fluid communication with the cathode channel input (26A), to provide catholyte from the catholyte reservoir (54; 154) to the cathode channel (26). {see, e.g., FIG. 4A; FIG. 4B}

P53: The apparatus (spray bottle) of P52, further comprising a catholyte pump (47;147′) in fluid communication with the catholyte reservoir (54; 154) to drive the catholyte from the catholyte reservoir (54; 154) to the cathode channel (26). {see, e.g., FIG. 4A; FIG. 4B}

P54: The apparatus (spray bottle) of P51, further comprising a source water pump (46) in fluid communication with the source reservoir (44;144A) and the electrolytic cell (20) to provide source water to the anode channel (24) and the cathode channel (26). {see, e.g., FIG. 3A; FIG. 3B}

P55: The apparatus (spray bottle) of P51 wherein the cathode channel (26) is fluidly isolated from the anode channel (24), the apparatus further comprising a source water pump (46; 146) in fluid communication with the source reservoir (44A; 144A) and configured to deliver source water to the anode channel (24), and a catholyte pump (47;147′) in fluid communication with the catholyte reservoir (54; 154) and configured to deliver catholyte to the cathode channel (26). {see, e.g., FIG. 4A; FIG. 4B}

P56: The apparatus (spray bottle) bottle of any of P51-P55, wherein the catholyte reservoir (54; 154) is fluidly isolated from the source reservoir (44A; 144A).

P61: A system for producing and dispensing ozonated water, comprising: a water source (44); an electrolytic cell (20) having an anode channel (24) having an anode channel input (24A) and an anode channel outlet (24B), and a cathode channel (26) having a cathode channel input (26A) and a cathode channel outlet (26B), the electrolytic cell (20) disposed in fluid communication with the water source (44) to receive source water from the water source (44) at both the anode channel input (24A) and the cathode channel input (26A); the anode channel outlet (24A) in fluid communication with a discharge nozzle (248) to deliver ozonated water to the discharge nozzle (248); and the cathode channel outlet (26B) is configured to be coupled in fluid communication with a drain (270). {see, e.g., FIG. 3C}

P62: The system of P61 wherein the water source (44) comprises a municipal water source.

P63: The system of any of P61-P62, wherein the cathode channel outlet (26B) is fluidly isolated from the anode channel outlet (24A).

P64: The system of any of P61-P63, wherein the discharge nozzle (248) is disposed to deliver ozonated water to a sink (249).

P64: The system of any of P61-P64, further comprising a valve (274) and a sensor (272), the sensor (272) in communication with the anode channel outlet (24B) to detect water flow out of the anode channel outlet (24B), the sensor (272) configured to open the valve (274) in response to detecting water flow out of the anode channel outlet (24B) to direct catholyte from the cathode channel outlet (26B) to the drain (270).

Various embodiments of the invention may be implemented at least in part in any conventional computer programming language. For example, some embodiments may be implemented in a procedural programming language (e.g., “C”), or in an object-oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods may be implemented as a computer program product for use with a computer system. Such implementation may include a series of computer instructions fixed either on a tangible medium, such as a non-transient computer readable medium (e.g., a diskette, CD-ROM, ROM, FLASH memory, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

Computer program logic implementing all or part of the functionality previously described herein may be executed at different times on a single processor (e.g., concurrently) or may be executed at the same or different times on multiple processors and may run under a single operating system process/thread or under different operating system processes/threads. Thus, the term “computer process” refers generally to the execution of a set of computer program instructions regardless of whether different computer processes are executed on the same or different processors and regardless of whether different computer processes run under the same operating system process/thread or different operating system processes/threads.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A system for generating ozonated water, the system comprising:
an electrolytic cell having a cell input configured to receive water from a water source and a power input configured to receive electrical power from a power source, the electrolytic cell comprising:
an anode passage in fluid communication with the cell input, the anode passage comprising an anode and an anode passage outlet, the anode configured to produce ozonated water (the anode stream) at the anode passage outlet; and
a cathode passage comprising a cathode and a cathode passage outlet, the cathode configured to produce a cathode stream at the cathode passage outlet,
wherein the cathode passage outlet is fluidly isolated from the anode passage outlet, such that the anode stream is fluidly isolated from the cathode stream;
an ozonated water output in fluid communication with the anode passage output; and
a catholyte discharge conduit comprising a catholyte scrubber in fluid communication with the cathode passage output and configured to receive the cathode stream and to produce scrubbed catholyte.

2. The system of claim 1, wherein the electrolytic cell further comprises a hydrogen-permeable (PEM) membrane disposed to fluidly isolate the anode passage from the cathode passage.

3. The system of claim 1, wherein the catholyte discharge conduit is in fluid communication with the water source and is configured to deliver catholyte from the cathode passage outlet to the water source downstream from the catholyte scrubber.

4. The system of claim 1, wherein the catholyte scrubber has an output in fluid communication with the ozonated water output to combine the scrubbed catholyte with the anolyte.

5. The system of claim 1 further comprising a mixing valve to combine the scrubbed catholyte with the ozonated water, wherein:
the catholyte scrubber has an output in fluid communication with the mixing valve;
the anode passage output is in fluid communication with the mixing valve, such that the scrubbed catholyte is mixed with the ozonated water in the mixing valve, and
the ozonated water output is coupled to the anode passage output via the mixing valve, and
the ozonated water output is coupled to the cathode passage output via the catholyte scrubber and the mixing valve.

6. The system of claim 1 further comprising a water source in fluid communication with the electrolytic cell to provide source water to the electrolytic cell.

7. The system of claim 1 further comprising a power source in power communication with the electrolytic cell.

8. The system of claim 7 further comprising a water source in fluid communication with the electrolytic cell to provide source water to the electrolytic cell.

9. The system of claim 1 further comprising a catholyte pump in fluid communication with the cathode passage outlet and the cathode passage inlet, the catholyte pump configured to provide catholyte to the cathode passage inlet of the second flow path of the electrolytic cell.

10. The system of claim 1, wherein the catholyte scrubber comprises a charcoal scrubber.

11. A spray bottle apparatus for producing and dispensing ozonated water, comprising:
a body comprising a source reservoir configured to hold source water;
a head comprising a nozzle for releasing ozonated water from the bottle; and
an electrolytic cell disposed in fluid communication with the nozzle and the source reservoir and configured to ozonate water as the water flows from the source reservoir to the nozzle, the electrolytic cell having:
an anode channel having an anode channel input and an anode channel output in fluid communication with the nozzle, and
a cathode channel having a cathode channel input and a cathode channel output, the cathode channel fluidly isolated from the anode channel; and
a catholyte scrubber in downstream fluid communication with the cathode channel output to receive catholyte from the cathode channel, and not in fluid communication with the anode channel output, the catholyte scrubber configured to produce scrubbed catholyte.

12. The spray bottle apparatus of claim 11, wherein the catholyte scrubber has a scrubber input and a scrubber output, the scrubber input fluidly coupled to the cathode channel output to receive catholyte from the electrolytic cell, and the scrubber output fluidly coupled to the anode channel output so as to combine the scrubbed catholyte with anolyte from the electrolytic cell.

13. The spray bottle apparatus of claim 11, wherein the catholyte scrubber has a scrubber input and a scrubber output, the scrubber input fluidly coupled to the cathode channel output to receive catholyte from the electrolytic cell, and the scrubber output fluidly coupled to the source reservoir to provide scrubbed catholyte to the source reservoir.

14. The spray bottle apparatus of claim 11, wherein:
the reservoir is in fluid communication with the cathode channel to provide source water from the reservoir to the cathode channel;
the catholyte scrubber has:
a scrubber input coupled to the cathode channel output to receive catholyte from the electrolytic cell, and
a scrubber output in fluid communication with the anode channel input to provide scrubbed catholyte to the anode channel of the electrolytic cell.

15. The spray bottle apparatus of claim 11, wherein the catholyte scrubber comprises a charcoal media.

16. The spray bottle apparatus of claim 11, wherein the catholyte scrubber comprises a bubble trap.

17. The spray bottle apparatus of claim 11, wherein the catholyte scrubber comprises a charcoal scrubber and a bubble trap.

18. A spray bottle apparatus for producing and dispensing ozonated water, comprising:
a body comprising a source reservoir configured to hold source water;
a head comprising a nozzle for releasing ozonated water from the bottle; and
an electrolytic cell disposed in fluid communication with the nozzle and the source reservoir and configured to ozonate water as the water flows from the source reservoir to the nozzle, the electrolytic cell having an anode channel having an anode channel output, and a cathode channel having a cathode channel output, the cathode channel fluidly isolated from the anode channel; and
a source water scrubber disposed in fluid communication between the source reservoir and the electrolytic cell to produce scrubbed source water to the electrolytic cell.

19. A spray bottle apparatus for producing and dispensing ozonated water, comprising:
a body comprising a source reservoir configured to hold source water;
a head comprising a nozzle for releasing ozonated water from the bottle; and
an electrolytic cell disposed in fluid communication with the nozzle and the source reservoir and configured to ozonate water as the water flows from the source reservoir to the nozzle, the electrolytic cell having an anode channel having an anode channel input and an anode channel output, and a cathode channel having a cathode channel output, the cathode channel fluidly isolated from the anode channel; and
a catholyte scrubber having a scrubber input and a scrubber output, the scrubber input fluidly coupled to the cathode channel output to receive catholyte from the electrolytic cell, and the scrubber output fluidly coupled to the anode channel input to provide scrubbed catholyte to the anode channel of the electrolytic cell.

20. The spray bottle apparatus of claim 19, wherein the catholyte scrubber comprises a charcoal scrubber.
